(19) United States
(12) Patent Application Publication
(10) Pub. No.: US 2015/0116997 A1
(43) Pub. Date: Apr. 30, 2015

(54) LED Lighting System for Promoting Biological Growth

(71) Applicant: ACROOPTICS, LLC, Boulder, CO (US)

(72) Inventors: Stephen Andrew Tappert, Boulder, CO (US); Michael Alexander Hurowitz, Boulder, CO (US); Kai Makoto Hudek, Durham, NC (US)

(73) Assignee: ACROOPTICS, LLC, Boulder, CO (US)

(21) Appl. No.: 14/527,721

(22) Filed: Oct. 29, 2014

Related U.S. Application Data
(60) Provisional application No. 61/896,851, filed on Oct. 29, 2013.

(51) Int. Cl. A01G 7/04; F21V 29/02; F21V 29/00; F21V 23/00; F21S 4/00

(52) U.S. Cl. CPC A01G 7/045; F21V 23/005; F21S 4/008; F21V 29/22; F21V 29/025; F21W 2131/308
USPC 362/231; 362/249.03

(57) ABSTRACT

The invention is directed to an LED lighting system for use in promoting biological growth. In one embodiment, the lighting system includes a plurality of “N” bar-like LED modules. Each of the LED modules is of the same length and the length is determined by the number of same-length LED circuit boards supported in an end-to-end manner by the LED module. The lighting system also includes a pair of bar-like end modules adapted to rigidly engage no more than “N” LED modules to realize a module structure in which the LED modules and the end modules respectively form the rungs and rails of a ladder-like structure. The lighting system is readily scalable in the length of the of the LED modules, as determined by the number of LED circuit boards supported, and in the number of LED modules supported by the pair of end modules.

### FIELD OF THE INVENTION

The invention is directed to a light emitting diode (LED) lighting system that operates in a manner that promotes biological growth.

### BACKGROUND OF THE INVENTION

Presently, there are numerous LED lighting systems designed to promote biological growth in the form of marine plants and animals, such as corals. These LED lighting systems can be categorized into two types. Characteristic of the first type is that the LEDs providing the light to promote the marine plant and/or animal growth are outside of the tank or other container in which the marine plants and/or animals whose growth is to be promoted are located. In the second type, the LEDs are located within the water that contains the marine plants and/animals. There are also many LED lighting systems designed to promote the growth of terrestrial plants.

Regardless of whether a particular LED lighting system is adapted to promote the growth of marine plants and/or animals or terrestrial plants, these systems typically have a number of common components. To elaborate, many of these systems have one or more circuit boards that each support a plurality of LEDs, a heat dissipation structure for removing heat generated by the operation of the LEDs, a housing or frame that supports the plurality of LEDs, and a controller that is used to manage the operation of the plurality of LEDs. In certain embodiments, subsets of the plurality of LEDs emit a particular wavelength of light that is different from the wavelengths of light being emitted by other subsets of the plurality of LEDs. In other embodiments, all of the plurality of LEDs emit the same wavelength/wavelengths of light (e.g., white light).

### SUMMARY OF THE INVENTION

In the case of LED lighting systems used to promote biological growth in marine environments, there are numerous “footprints” for such environments. For example, many standard aquarium sizes have lengths that come in approximately 1-foot multiples (e.g., 24, 36, 37, 48, 49, 72, and 73 inches) and widths that come in approximately 6 inch multiples (e.g., 12, 13, 18, and 24 inches). Similarly, in the case of LED lighting systems used to promote the growth of plants in terrestrial environments, there are numerous “footprints” for such environments. However, in many such applications, the terrestrial plants whose growth is to be promoted are situated in a row or parallel rows that each has a length and a substantially constant width.

An LED lighting system is provided that can be readily scaled to accommodate the rectangular footprints associated with many marine and terrestrial applications. In this regard, an LED lighting system is provided that provides a plurality of LED modules that each extend from first terminal end to a second terminal end, have a longitudinal axis, and have substantially the same length as measured between the terminal ends. The system further includes first and second end modules that each extend from a first terminal end to a second terminal end and have a longitudinal axis. The first end module is rigidly engaged to the first terminal end of each of the LED modules. The second end module is rigidly connected to the second terminal end of each of the LED modules. The structure resulting from the rigid engagements disposes the longitudinal axes of the LED modules substantially parallel to one another, the longitudinal axes of the first and second end modules substantially parallel to one another, and the longitudinal axes of the LED modules substantially perpendicular to the longitudinal axes of the end modules. As such, the resulting module structure has a ladder-like characteristic. As should be appreciated, such a structure is readily scalable. To elaborate, LED modules can be fabricated to have various lengths. For example, LED modules could be fabricated to have lengths of one-foot, two-feet, and three or more feet. Similarly, end modules can be fabricated to accommodate two, three, or more LED modules. These LED modules and end modules can be combined to form LED lighting systems with numerous different footprints. To continue with the example, two two-foot long LED modules can be rigidly joined to two end modules that are each capable of accommodating two LED modules to provide an LED lighting system for an aquarium that has a two-foot length and a defined depth; two three-foot long LED module could be rigidly joined to the same two end modules to provide an LED lighting system for an aquarium that has a three-foot length and the same defined depth; and so on to realize a number of LED lighting systems with different footprints that each has a different length but the same depth. Similarly, two two-foot long LED modules can be rigidly attached to two end modules that are each capable of accommodating two LED modules to provide an LED lighting system for an aquarium that has a two-foot length and a particular depth; three two-foot long LED modules can be rigidly attached to two end modules that are each capable of accommodating three LED modules to provide an LED lighting system for an aquarium that has a two-foot length and a greater depth; and so on to realize a number of LED lighting systems with different footprints that each has the same length but a different depth.

In a particular embodiment of the LED lighting system, the LED module each support a plurality LED circuit boards that each support a plurality of LEDs. The LED circuit boards are each of substantially the same length and are disposed in a linear fashion. As such, the LED circuit boards contribute to the scalability of the LED lighting system. For example, if a LED modules are manufactured beginning with a two-foot length and increasing in length in one-foot increments, an LED module that is nominally two-feet in length can support two or more circuit boards of the same length that are linearly disposed and that can be fit within the nominal two-foot length and an LED module that is nominally three-fee in length can support a greater number of circuit boards of the same length. In one embodiment, the LED circuit boards are disposed end-to-end. By disposing the LED circuit boards end-to-end, the uniformity of the light produced over the target area (e.g., the water surface of an aquarium) can be improved relative LED circuit boards that are spaced from one another. Yet another embodiment employs LED circuit boards in which LEDs associated with each LED circuit board are connected in parallel with one another on the LED circuit board (i.e., with cathodes connected together and anodes connected together) and connected in series with LEDs associated with an immediately adjacent LED circuit board. This also facilitates the scalability of the LED lighting system by allowing the maximum power requirement of each of the LED circuit boards to be fixed.

In another embodiment of the lighting system, each of the LED modules has a substantially uniform cross-section between the terminal ends and these cross-sections are substantially identical to one another. The cross-section is defined in part by a heat sink structure that extends between the terminal ends of the module and has an H-shaped cross-section. Each of the two outer upright sections of the H-shaped cross-section is associated with an external lateral side of the module. As such, the lateral and parallel sides of each of the modules dissipate heat produced by the operation of the LEDs associated with the module. In a particular embodiment, the heat sink includes a number of fins that each extends outward from the cross-member of the H-shape and along substantially the entire length of the LED module. In a further embodiment, a cap extends across the top ends of the upright members of the H-shape so that the LED module defines an enclosed space defined by the cap, the cross-member of the H-shape, and the portions of upright sections of the H-shape that extend between the cross-member and the cap. A fan is disposed in this enclosed space to move air warmed by the operation of the LEDs away from the LEDs. In a particular embodiment, the enclosed space associated with the LED module is in communication with an enclosed space associated with at least one of the end modules and the fan operates to additionally move air warmed by the operation of electronic circuitry located in the end module away from the circuitry.

### BRIEF DESCRIPTION OF THE DRAWINGS

FIG. 1 shows an exemplary embodiment of the invention as adapted for use over an aquarium;

FIG. 2 shows an exemplary embodiment of a partially constructed lighting module;

FIG. 3 shows an exemplary embodiment in cross section of an elongated member as used in an in an embodiment of the claimed lighting system;

FIG. 4 shows a top view of an exemplary embodiment of a Total Internal Reflection lens array as used in an embodiment of the claimed lighting system;

FIG. 5 shows a side view of an exemplary embodiment of a Total Internal Reflection lens array as used in an embodiment of the claimed lighting system;

FIG. 6 shows an exemplary embodiment of a LED light board;

FIG. 7 shows an exemplary embodiment PCB used in the LED light board;

FIG. 8 shows an exemplary circuit for a string of amber LED lights;

FIG. 9 shows an exemplary circuit for a string of blue LED lights;

FIG. 10 shows an exemplary circuit for a string of red LED lights;

FIG. 11 shows an exemplary circuit for a string of white LED lights;

FIG. 12 shows an exemplary circuit for a string of UV LED lights;

FIG. 13 shows an exemplary circuit for a string of blue LED lights;

FIG. 14 shows an exemplary circuit for a string of amber LED lights;

FIG. 15 shows the CRAVE spectra for plants and corals;

FIG. 16 shows the coral CRAVE spectra compared with the spectral output from a variety of LED light systems including an embodiment of the present invention;

FIG. 17 shows the coral CRAVE Index vs. wavelength for various lighting systems including an embodiment of the present invention;

FIG. 18 shows an exemplary embodiment of an electronics end box adapted to include a user interface system;

FIG. 19 shows another embodiment of an electronics end box;

FIG. 20 is a cross sectional view of an exemplary embodiment of the lighting module sub assembly;

FIG. 21 shows an exemplary embodiment of a lighting module, including a Total Internal Reflection lens array;

FIG. 22 shows an embodiment of a microcontroller as used by an embodiment of the invention;

FIG. 23 shows an embodiment of the LED driver;

FIG. 24 illustrates a second embodiment of aquarium lighting unit engaged to an aquarium;

FIGS. 25A-25C are different perspective views of the lighting fixture of the second embodiment of the aquarium lighting unit illustrated in FIG. 24;

FIG. 25D is an exploded view of the lighting fixture of the second embodiment of the aquarium lighting unit illustrated in FIG. 24;

FIG. 26 is a perspective view of an LED lighting module associated with the lighting fixture illustrated in FIGS. 25A-25D;

FIG. 27 is an exploded view of the LED lighting module illustrated in FIG. 26;

FIG. 28 is a cross-sectional view of an elongated member associated with the LED lighting module illustrated in FIG. 26;

FIG. 28A is a cross-sectional view of the LED lighting module illustrated in FIG. 26;

FIG. 29 is a perspective view of a second embodiment of a TIR lens array structure associated with the LED lighting module illustrated in FIG. 26;

FIG. 30 is an exploded view of a first end module of the lighting fixture illustrated in FIGS. 25A-25D;

FIG. 31 is an exploded view of a second end module of the lighting fixture illustrated in FIGS. 25A-25D;

FIG. 32 a plan view of the lighting fixture illustrated in FIGS. 25A-25D;

FIG. 33 illustrate the electrical connections used to convey control signals between the LED light boards of the lighting fixture illustrated in FIGS. 25A-25D;

FIG. 34 illustrate a lighting fixture that employs three LED lighting modules that are scaled down relative to the lighting modules associated with the lighting fixture illustrated in FIGS. 25A-25D; and

FIG. 35 is an exploded view of one of the lighting fixture shown in FIG. 34.

### DETAILED DESCRIPTION

At the outset, it should be appreciated that while the present invention is described with respect to what is presently considered to be the preferred embodiments, it is to be understood that the invention is not limited to the disclosed aspects.

Furthermore, it is understood that aspects of the invention are not limited to the particular methodology, materials and modifications described and as such may, of course, vary. It is also understood that the terminology used herein is for the purpose of describing particular aspects only, and is not intended to limit the scope of the present invention.

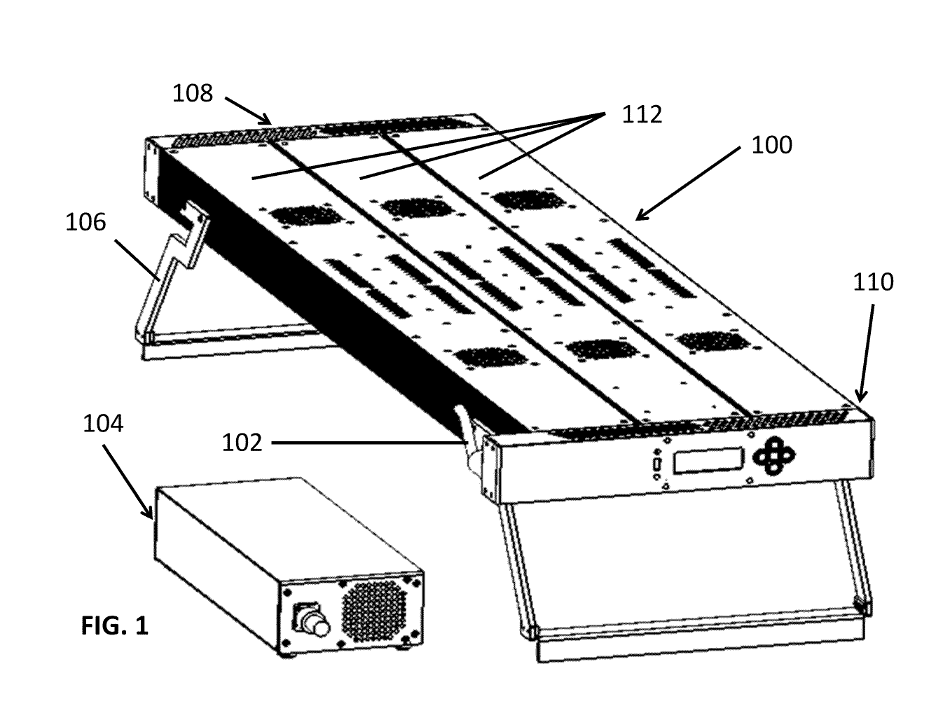

FIG. 1 shows an exemplary embodiment of the invention as adapted for use as an aquarium lighting unit 100. Aspects of this embodiment include a pair of legs 106, three lighting modules 112, a power cable 102, a user interface end box 110, an end box 108 and a power box 104.

The embodiment in FIG. 1 is adapted for use on a 48-inch aquarium. The legs 106 attach to nuts within the side channels 212 on the side of the elongated members 214. Thus this embodiment is suitable for lighting a wide variety of aquarium sizes. Each of the legs 106 can be made of a wide variety of suitable materials, including but are not limited to; aluminum, steel, or plastic, with aluminum currently preferred.

The aquarium lighting unit 100 is powered at 48 volts supplied by the power box 104 via the power cable 102. The 48 volts is a preferred voltage because the regulatory concerns of using high voltage are not present and 48 volts is sufficient to drive an extended string of LED lights. However, the choice to use 48 volts is one aspect of the preferred embodiment and other embodiments may use other voltages. Since another aspect of the invention is a modular lighting system suitable for use in very large arrays, the voltage required by a lighting unit designed in accordance with the invention will also depend upon the number of LED light boards 600 used in each lighting module 112.

In this embodiment, there are three lighting modules 112 located adjacent to one another. However, because one aspect of the invention is a modular lighting system suitable for use in very large arrays, different embodiments of the invention contemplate any number of lighting modules 112 and configurations. For use an aquarium lighting unit 100, three lighting modules 112 provide sufficient light footprint and SPD for a 48-inch aquarium.

In the aquarium lighting unit 100, the power cable 102 connects the power box 104 to the user interface end box 110. The user interface end box 110 is attached to the lighting modules 112 using mechanical fasteners. On the opposite end of the lighting modules 112 from the user interface end box 110, an end box 108 is attached to the plurality of lighting modules 112. The end box 108 in this embodiment is attached with a plurality of mechanical fasteners.

The embodiment of the invention disclosed in FIG. 1 is operable for lighting an aquarium of approximately 48 inches in length. During operation, the user of the lighting device will plug the cable (not shown) from the power box 104 into a residential wall outlet. The user can then power the lighting device with a power switch located on the power box 104. The aquarium lighting unit 100 will be positioned on top of the aquarium with the legs 106 resting on the lip of the aquarium top. The user can control the light output of the aquarium lighting unit 100 via the user interface end box 110. Each of the lighting modules 112 will shine light generated by a plurality of LEDs into the tank in accordance with the capabilities of the system, and the SPD profile desired by the user.

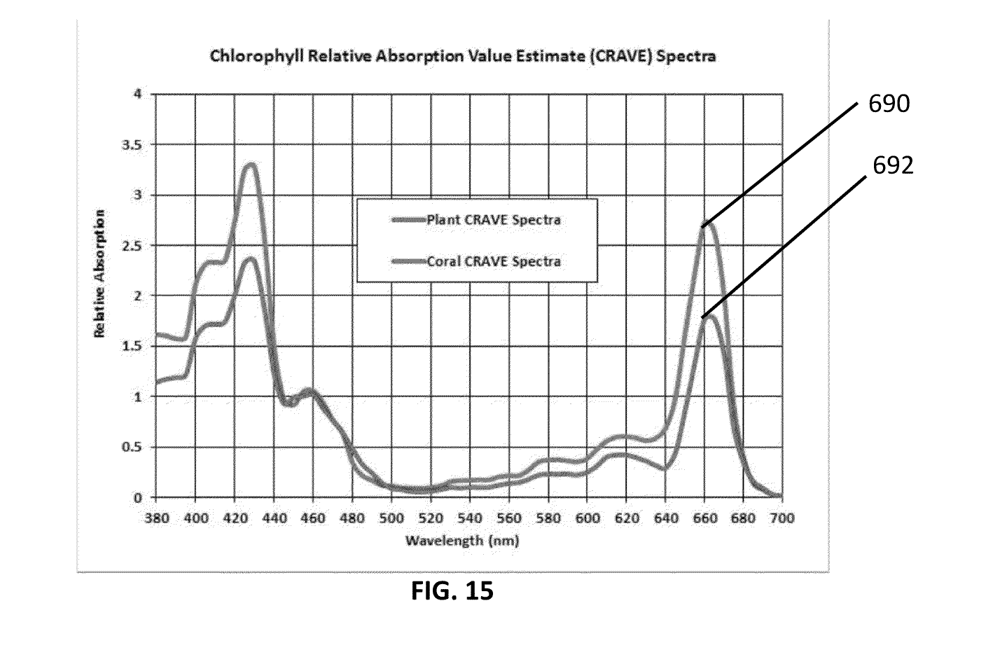

Among the many improvements over the prior art, one aspect of the invention is a lighting system designed to produce light with a SPD that mimics the CRAVE spectra. FIG. 15 is a chart that shows the plant CRAVE spectra 690 and the coral CRAVE spectra 692. CRAVE stands for chlorophyll relative absorption value estimate. The plant CRAVE spectra 690 can be used to produce an index that rates light sources based on their ability to drive photosynthetic processes.

The CRAVE spectra method compares the relative needs of different chlorophyll in photosynthetic organisms with the SPD of a given light source. This is an entirely new way of thinking about relative performance of different light sources. In plants Chlorophyll A is found 3:1 to Chlorophyll B and in coral reefs Chlorophyll A is found 2:1 to chlorophyll C2. These ratios are approximations and the exact ratio will vary with each plant or coral species. Chlorophyll A is most efficient in absorbing light with a wavelength of 430 nm or 660 nm. Chlorophyll B is most efficient in absorbing light with a wavelength of 453 nm or 642 nm. Chlorophyll C2 is most efficient in absorbing light with a wavelength of 444 nm or 630 nm,

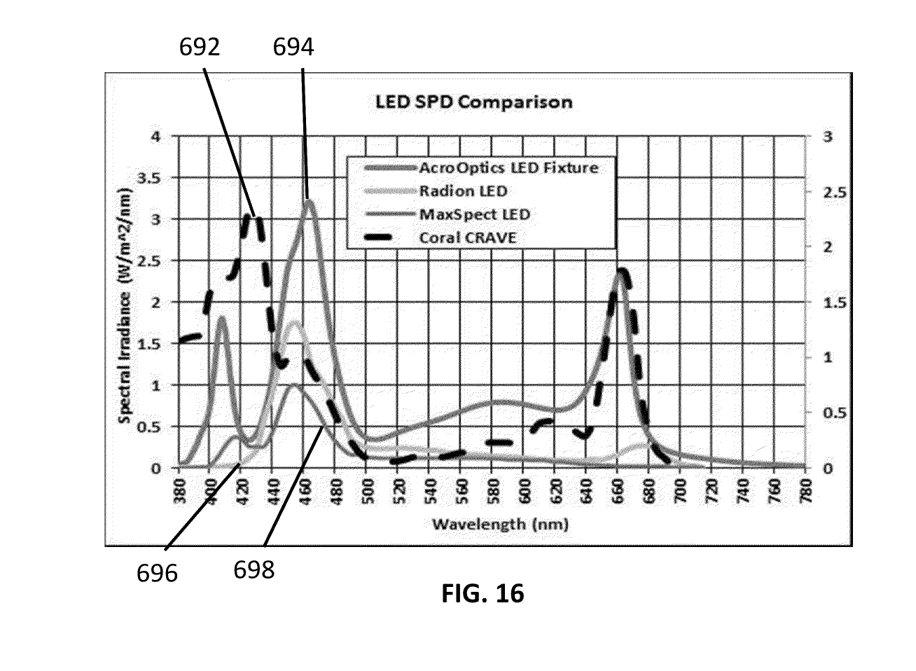

A CRAVE spectra shows the relative efficiency of a given plant or coral in converting light of a given wavelength into energy. FIG. 16 shows the SPD profiles of two prior art LED lighting systems (the SPD profile 696 for the Radion LED system, and the SPD profile 698 for the MaxSpect LED system) and the SPD profile 694 of the aquarium lighting unit 100, and the coral CRAVE spectra 692. Notably, the present invention was explicitly designed to allow the tuning of the SPD profile to match a given coral or plant CRAVE spectra. FIG. 16 shows that the SPD profile 694 of the aquarium lighting unit 100 is a much closer fit to the coral CRAVE spectra 692 than prior art coral grow lights. Particularly, the result is that the aquarium lighting unit 100 is far more efficient than prior art at promoting coral growth, because the aquarium lighting unit 100 is not wasting energy producing light in wavelengths that are minimally absorbed by the targeted coral.

The use of the CRAVE spectra method is applicable to any lighting system designed for promoting biological growth. Maximizing the production of light in wavelengths where a target is most efficient at converting light into energy reduces the total amount of light the lighting system must produce. For each type of photosynthetically active target, the target CRAVE spectra will change, but the method of designing or operating a light to maximally mimic a particular CRAVE spectra is still applicable.

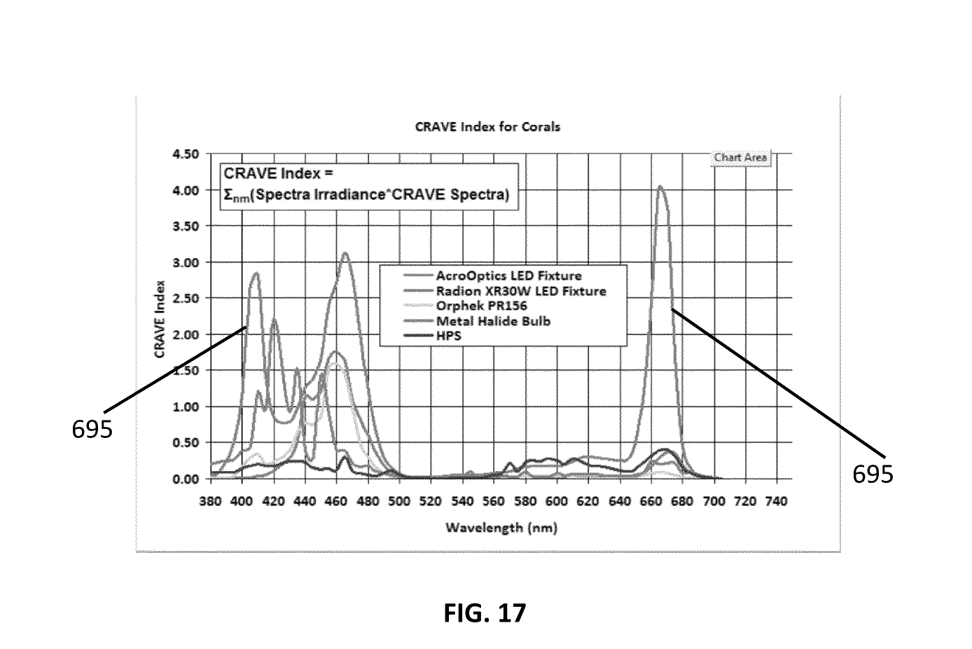

In some embodiments, the CRAVE spectra method produces a single number, the CRAVE Index. By designing the SPD from a light source to maximize this number, a given light source is optimized for promoting biological growth of a target plant or coral. In this embodiment the SPD from a given light source is first measured (see FIG. 16). Next, the relative absorption spectrum of the target plant or coral is taken from existing literature or found experimentally. While using the absorption spectrum unique to the target species is preferable, the CRAVE spectra method envisions embodiments that use a general absorption spectrum such as the plant and coral CRAVE spectra 690, 692 shown in FIG. 15. Next, the spectral irradiance of the light source at each wavelength is multiplied by the relative absorption spectrum value at that given wavelength. The result is a chart of the CRAVE Index vs. wavelength for the light source, as shown in FIG. 17. The line identified on this chart as 695 is the line that results from performing the aforementioned steps with the SPD profile 694 from the aquarium lighting unit 100 and the coral CRAVE spectra 692. The total area under the line on the CRAVE Index vs. wavelength chart is a single number that is the CRAVE Index for that light source. The larger the number, the better the light source is adapted to promote biological growth in the target plant or coral.

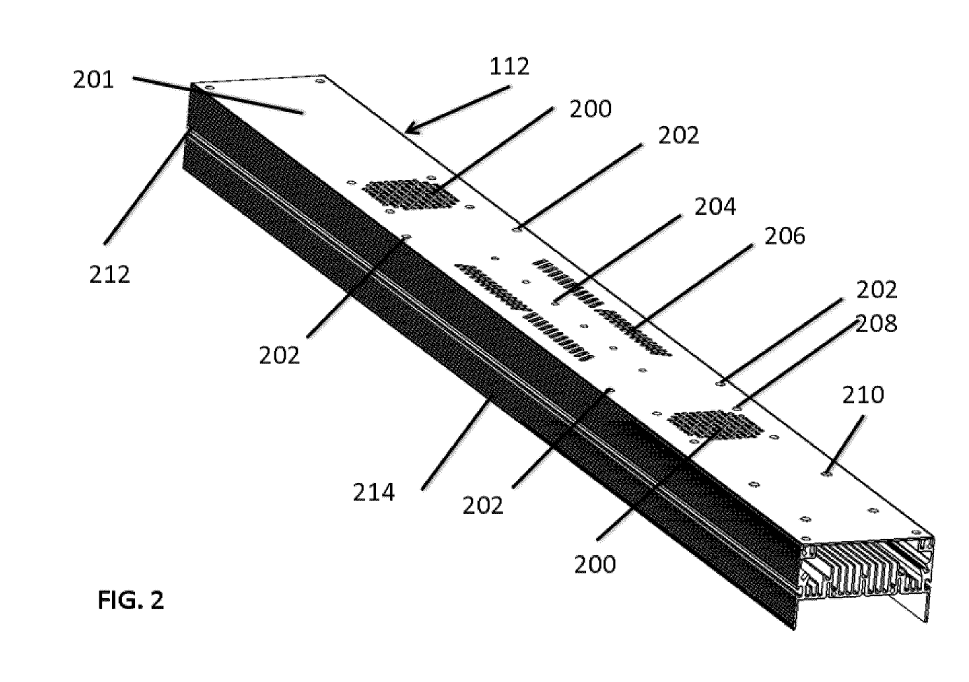

FIG. 2 shows an exemplary embodiment of a partially constructed lighting module 112. There are two parts disclosed in the embodiment shown in FIG. 2, the top panel 201 and the elongated member 214. The top panel 201 is attached to the elongated member 214 with a plurality of mechanical fasteners (not shown). The mechanical fasteners are placed through a plurality of top panel mounting holes 202 and secured into top panel mounting channels 306 in the elongated member 214. In the preferred embodiment, the mechanical fasteners are self-tapping sheet metal screws. However, aspects of the present invention include the top panel 201 being secured to the elongated member 214 via any number of methods including a slip fit beneath a lip, welding, or bonding.

The top panel 201 also includes a plurality of holes for mounting different hardware necessary for this embodiment of the present invention. These include a plurality of fan mounting holes 208, a plurality of microcontroller mounting holes 210 and a plurality of LED driver mounting holes 204. In this embodiment, any hardware that is attached to the top panel 201 is attached with standard mechanical fasteners.

The top panel 201 also includes top panel ventilation slots 206 and fan outlet vents 200. Aspects of the present embodiment envision a wide variety of possible numbers, sizes, shapes and configurations of top panel ventilation slots 206, and fan outlet vents 200. The top panel ventilation slots 206, the fan outlet vents 200, the end box ventilation slots 800 and user interface end box ventilation slots 712 provide cooling air flow during the operation of the plurality of fans 900 mounted in the lighting module 112.

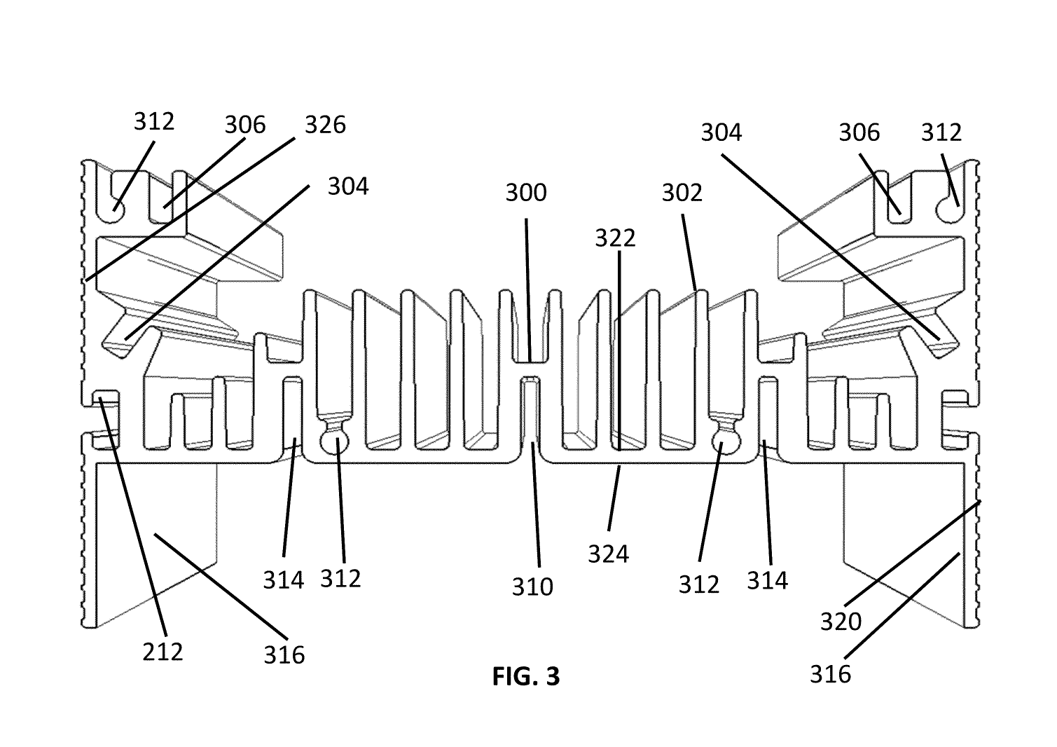

FIG. 3 shows a cross section of an embodiment of an elongated member 214 as used in an exemplary embodiment of the claimed lighting unit. In this embodiment, the elongated member 214 is used as a frame member, a heat sink member and an aesthetic member. In a preferred embodiment, the elongated member is constructed of extruded aluminum. However, the invention envisions various embodiments of the elongated member 214, wherein the elongated member is comprised of steel, a resin and glass or carbon fiber composite, or any other material(s) that have suitable mechanical properties. Suitable mechanical properties include having sufficient thermal conductivity to act as a heat sink for removing heat from the LED light boards 600, and sufficient strength to support a plurality of components. The preferred embodiment of the elongated member 214 includes exterior ridges 320 along the outer edges of the elongated member 214. The raised ridges 320 create a superior aesthetic finish when compared to a similar extruded, unfinished, and flat surface.

The elongated member 214 includes a plurality of mounting locations, cooling fins and features adapted for use in a modular lighting system. In this embodiment, the elongated member 214 has a substantially H-shape comprised of a central web and two flange sections. The central web is comprised of a plurality of cooling fins 302 and mounting channels. The mounting channels include a thermocouple mounting channel 300, a plurality of end box mounting channels 312, a LED board mounting channel 310, and a plurality of lens mounting channels 314. In this embodiment, the two flanges are comprised of end box mounting channels 312, side channels 212, cable routing clip mounts 304, top panel mounting channels 306, lower sidewalls 316 and exterior raised ridges 320.

While the configuration of the elongated member 214 in this embodiment includes the aforementioned channels the use of mounting channels, the use of mounting channels is applicable to a wide number of embodiments. In operation that each channel is designed for use with self-tapping sheet metal screws so that no tapping operations are required for manufacture. For example, when attaching the top panel 201 to the elongated member 214 the practitioner will first align the plurality of top panel mounting holes 202 in the top panel 201 with the top panel mounting channels 306. The practitioner will then thread self-tapping sheet metal screws through the top panel mounting holes 202 and into the top panel mounting channels 306.

Referring now to the central web portion of the elongated member 214, the central web has a top surface 322 and a bottom surface 324. The top surface 322 comprises the thermocouple mounting channel 300, a plurality of end box mounting channels 312, and a plurality of cooling fins 302. The bottom surface 324 comprises a plurality of lens mounting channels 314 and a LED board mounting channel 310.

Referring now to the bottom surface 324 in more detail, the bottom surface provides a mounting location for, and acts as a heat sink for, the LED light board 600. In order to function as a heat sink, the bottom surface 324 should be substantially flat. This allows the LED light board 600 to sit flush against the aluminum of the elongated member 214. A flush contact between the LED light board 600 and elongated member 214 promotes the effective removal of heat from the LED light board 600 to the elongated member 214. The heat is then transferred via the plurality of cooling fins 302 to the air contained within the enclosed area defined by the top panel 201 and the top surface 322 of the elongated member. The heat transferred to the air contained within the enclosed space is then removed via a plurality of fans 900 which circulate air at ambient temperature through the enclosed space.

The use of the elongated member 214 in the modular system overcomes a difficulty in the prior art of creating a modular lighting system. Previous attempts at designing LED lighting systems for promoting biological growth have failed to create a modular design where the lighting system can be adapted for different uses and scales without a substantial redesign of the system and a duplication of system components. An aspect of the present invention is a lighting system designed to be suitable for use in very large arrays. By using one or more individual lighting modules 112, the light footprint and total amount of light produced can be varied for individual applications by varying the number and location of lighting modules 112. Additionally, the amount of light produced by each lighting module can be increased or decreased by changing the length of the elongated members 214, and number of LED light boards 600 used by each lighting module 112. By using an elongated member 214 with constant cross-section for the light module 112 chassis, such a modification does not require a significant redesign of the lighting module 112. The use of mounting channels provides the same mounting locations for additional LED light boards 600 when a longer elongated member 214 is used.

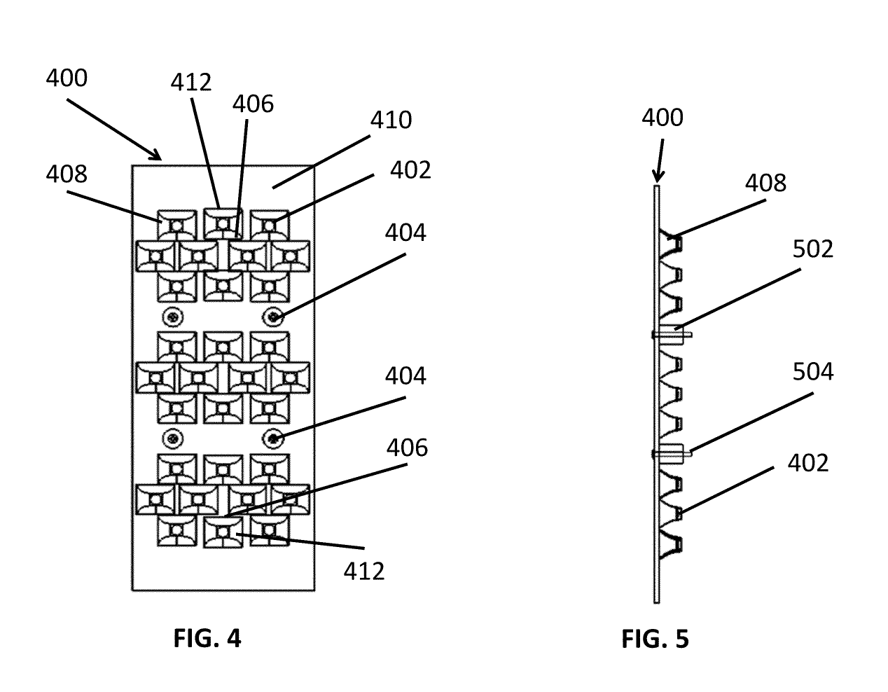

FIG. 4 shows a top view of an exemplary embodiment of a Total Internal Reflection (TIR) lens array 400 used in the aquarium lighting unit 100. The TIR lens array 400 is comprised of a plurality of total internal reflection lens 408, a plurality of lens array mounting holes 404 and backing board 410. Each TIR lens array 400 is sized and designed to function with a single LED light board 600.

Referring now to the total internal reflection lens 408 in more detail, each total internal reflection lens 408 is designed to give a substantially rectangular foot print. The total internal reflection lens 408 may be made out of any material and by any method for producing optical elements. However the preferred material is a ZNX330R plastic, which was chosen for UV resistance and superior thermal characteristics. The TIR lens array 400 was produced using injection molding.

The desired footprint of the light exiting the total internal refection lens 408 can be adapted to fit a wide variety of needs as dictated by a particular embodiment of the invention. In the preferred embodiment, each total internal reflection lens 408 is designed to give a substantially rectangular footprint of light. In doing so, the light produced by the LED light board 600 exits the aquarium lighting unit with a substantially rectangular footprint. The rectangular footprint is well matched to lighting aquariums that are generally rectangular in shape.

Referring to the rectangular pattern of light in more detail, such a light pattern helps to prevent a phenomena know as spot lighting. When designing a lighting system for promoting biological growth in an aquarium, or any other type of growing environment, it is important to ensure that the light lands upon the target in a well-distributed and even pattern. When using conventional lighting systems (such as Sodium Halide, or Mercury Vapor), the light emitted by the system is emitted in a variety of wavelengths from a single point source. However, when designing a lighting system using LED lighting elements, the designer must take into account the fact that each LED element emits a narrow wavelength of light. In poorly designed systems, a LED lighting system may create a pattern of areas within the illuminated area where there are increased intensities of particular wavelengths of light and areas where there is a lesser intensity of particular wavelengths of light. This phenomenon, known as spotlighting, is undesirable when designing a light for promoting biological growth.

Each total internal reflection lens 408 is located over an individual LED element and is designed with a recessed opening 402 in which one of the plurality of LED light elements contained on the LED light board 600 fits. The purpose of the recessed opening 402 is to provide a tight fit of the total internal reflection lens 408 about a particular LED element and maximize the amount of light that enters the total internal reflection lens 408.

FIG. 4 further discloses an offset spacing 406 between the plurality of total internal reflection lenses 408 and the offset total internal reflection lenses 412. The offset total internal reflection lens 412 is separated by the offset spacing, in part because the offset total internal reflection lens is designed to be non-perpendicular to the backing board 410. The offset total internal reflection lens 412 is offset so that the light exiting the lens is directed away from the edge of the TIR lens array nearest to the offset total internal reflection lens 412. In practice, this design feature promotes the overall efficiency of the aquarium lighting unit 100 by minimizing the light that is lost as leakage through the sides of an aquarium lit by the aquarium lighting unit 100.

FIG. 5 shows a side view of the TIR lens array 400 as used in an exemplary embodiment of the aquarium lighting unit 100. The TIR lens array 400 is secured to the elongated member with a plurality of fasteners 504 and a plurality of lens array spacers 502. Each fastener 504, in operation, is inserted through the lens array mounting holes 404, through a lens array spacer 502, through a hole (not shown) in the LED light board 600, and then threaded into the respective lens mounting channel 314. The lens array spacers 502 are sized such that when the TIR lens array 400 is secured to the elongated member 214, the edges of the backing board 410 rest firmly against or near to the bottom edges of the lower sidewalls 316. In some embodiments the combination of the lower sidewalls 316, the TIR lens arrays 400, the bottom surface 324, the end box 108, and the user interface end box 110, creates an enclosed space that isolates the LED light board 600 from the environment. This feature is particularly effective in preventing water from an aquarium from contaminating the LED light board 600. However, in other embodiments, such as when the present invention is adapted for indoor commercial farming, the lighting system does not require a TIR lens array 400 or if one is present the TIR lens array 400 need not fully isolate the LED light board 600 from the environment.

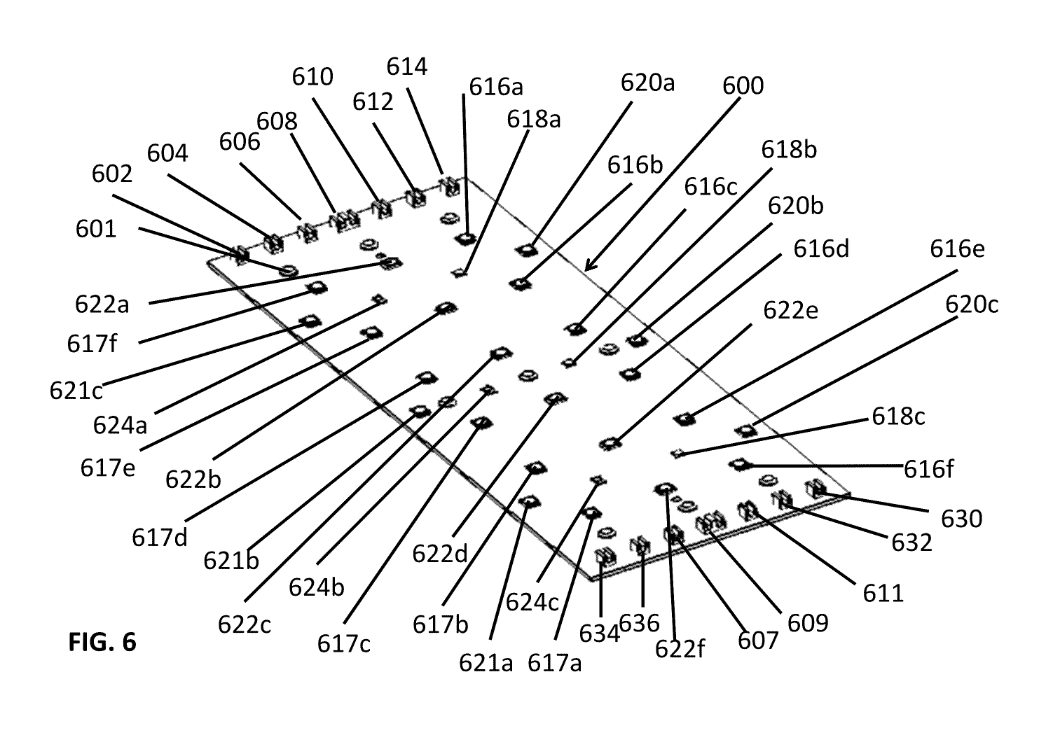

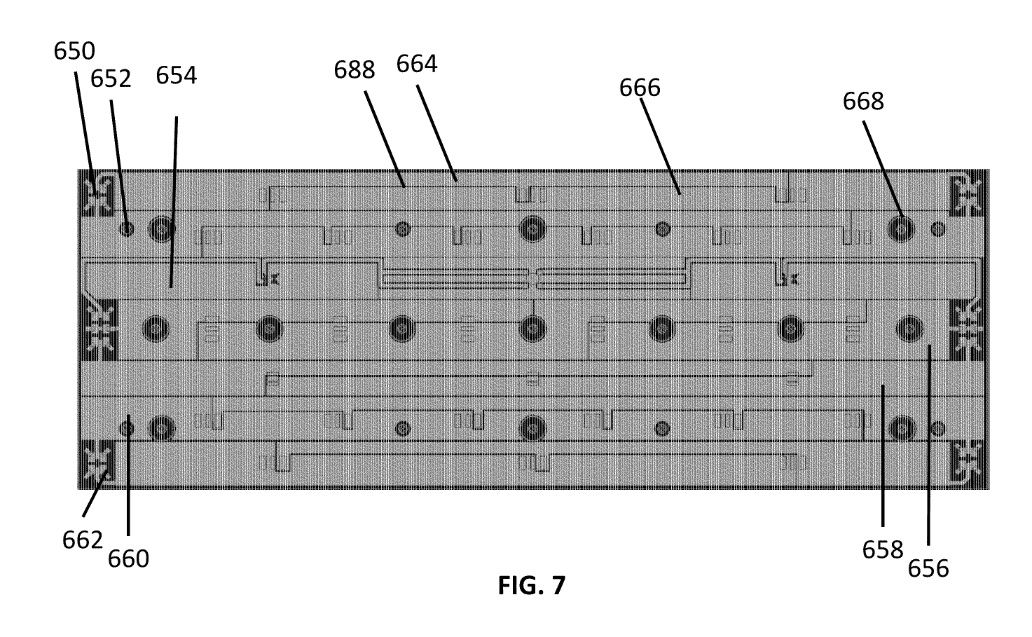

FIGS. 6 and 7 show an exemplary embodiment of a LED light board 600. At the outset it should be understood that the LED light board 600 described in FIG. 6 is simply one embodiment of a suitable configuration of LED and circuit board elements. To one skilled in the art of electrical engineering, numerous variations would be understood as disclosed by the following description. These variations would include the number of LED elements, the type of LED elements, the arrangement of the elements, the weight and construction of the circuit board and traces, and the location and number of mounting holes provided.

One embodiment of the invention uses lighting modules 112 that contain four LED light boards 600 per module. However, each LED lighting board 600 is designed to be modular in nature as required by a lighting system adapted for use in very large arrays. By designing for modularity, various embodiments of the invention are envisioned ranging from aquarium lighting unit 100 to lighting systems designed to provide light for indoor commercial farming operations of several thousand square feet.

In the preferred embodiment, the LED light board 600 is constructed from an aluminum PCB with heavy copper fill (4 to 10oz). The LED light board 600 is constructed from aluminum in the preferred embodiment. The pads on the LED light board 600 are protected with electroless nickel immersion gold (ENIG) plating. The preferred embodiment uses an ENIG coating, but any number of more conventional plating methods, such as solder, may be used.

The plurality of mounting holes 668 provided on the LED light board 600 are free of copper and solder mask so that the aluminum PCB is tied to the chassis ground. Notably, the LED light board 600 carries only a plurality of LEDs and jumper interfaces. All other circuitry necessary for controlling the aquarium lighting unit 100 is contained within other enclosed parts of the aquarium lighting unit 100, such as the user interface end box 110, the end box 108, or the elongated region defined by the top surface 322, the upper sidewalls 326 and the top panel 201.

The LED lighting board 600 uses thick copper traces (anode trace 664 and cathode trace 666) in order to minimize the electrical losses due to the resistance of the copper traces. Particularly in a lighting system that powers multiple LED light boards 600, the resistance in the traces can consume a significant amount of electrical power. Thus, it is desirable for the traces to have as little resistance as possible so that the lighting system will be more efficient and the LED light board 600 will not experience undesirable heating.

FIG. 7 depicts the LED light board 600 for use in the aquarium lighting unit 100. This embodiment comprises an upper amber LED string 650, an upper blue LED string 652, a red LED string 654, a white LED string 656, a UV LED string 658, a lower blue LED string 660 and a lower amber LED string 662. The anode trace 664 and the cathode trace 666 are depicted for the upper amber LED string 650. The LED light board 600 uses heavy copper traces. Notably the traces take up the maximum amount of area on the PCB while leaving an insulating gap 688 between the anode trace 664 and cathode trace 666. This same architecture is used on the PCB for each string of LED elements.

Returning to FIG. 6, FIG. 6 depicts a plurality of jumper interfaces including the amber return jumper 602, the blue return jumper 604, the UV in jumper 606, the white in jumper 608, the red in jumper 610, the blue in jumper 612 and the amber in jumper 614. On the opposite side of the LED light board 600 (relative to the long axis) there are another plurality of jumpers including the amber out jumper 630, the blue out jumper 632, the red out jumper 611, the white out jumper 609, the UV out jumper 607, second blue in jumper 636, the second amber in jumper 634. The LED light board shown in FIG. 7 is slightly different from the LED light board 600 shown in FIG. 6, namely, certain of the jumper interfaces are embodied in a single monolithic structure that includes two or more of the jumper interfaces.

An LED string is comprised of a plurality of LEDs, anode and cathode traces that are used to electrically connect the plurality of LEDs to one another, a jumper interface connected to the anode trace, and a jumper interface connected to the cathode trace. The jumper interfaces each provide a point of electrical contact for a jumper wire that engages another jumper interface associated with another LED light board 600 to electrically connect a string of LEDs associated with one LED light board to a string of LEDs associated with another LED light board. The jumper interfaces also provide a point of electrical contact for a jumper wire that electrically connects a LED light board 600 with electrically circuitry other than a string of LEDs associated with another LED light board. For example, certain of the jumper interfaces associated with the LED light board 600 that is the first or last LED light board in a string of LED light boards connected in series to one another provide a point of electrical contact for a jumper wire that connects the LED light board to circuitry associated with an LED driver board 1200.

The plurality of jumpers is used to drive a plurality of strings of LED lights of a single color. The layout of LED light elements in FIG. 6 is simply a preferred embodiment of the layout of LED light elements on the LED light board 600; however the number and type of LED light elements on the LED light board 600 could vary significantly in different embodiments of the invention. The plurality of LED strings 650, 652, 654, 656, 658, 660, 662 could vary in other embodiments both in the wavelength of light emitted by the LED elements powered on a given string, and in the total number of LED light strings.

One of the plurality of LED light strings is comprised of a plurality of amber LED elements 620a, 620b, 620c. Preferably, the amber LED elements are Nichia NS6A183 LED elements. The term ‘amber LED’ is used in the detailed description to refer to a LED with a peak emission at around 600 nm.

One of the plurality of LED light strings is comprised of a plurality of blue LED elements 616a, 616b, 616c, 616d, 616e, 616f. Preferably, the blue LED elements are Nichia NS6B083 LED elements. The term ‘blue LED’ is used in the detailed description to refer to a LED with a peak emission at around 465 nm.

One of the plurality of LED light strings is comprised of a plurality of red LED elements 618a, 618b, 681c. Preferably, the red LED elements are Luxeon Rebel Deep Red Wavelength LED elements. The term ‘red LED’ is used in the detailed description to refer to a LED with a peak emission at around 645 nm.

One of the plurality of LED light strings is comprised of a plurality of white LED elements 622a, 622b, 622c, 622d, 622e, 622f. Preferably, the white LED elements are Nichia NS6W183 LED elements. The term ‘white LED’ is used in the detailed description to refer to a LED with a peak emission at around 440 nm.

One of the plurality of LED light strings is comprised of a plurality of ultra violet (UV) LED elements 624a, 624b, 624c. Preferably, the UV LED elements are SiBDI SI-35 near UV diode elements. The term ‘UV LED’ is used in the detailed description to refer to a LED with a peak emission at around 410 nm.

One of the plurality of LED light strings is comprised of a plurality of blue LED elements 617a, 617b, 617c, 617d, 617e, 617f. Preferably, the blue LED elements are Nichia NS6B083 LED elements.

One of the plurality of LED light strings is comprised of a plurality of amber LED elements 621a, 621b, 621c. Preferably, the amber LED elements are Nichia NS6A183 LED elements.

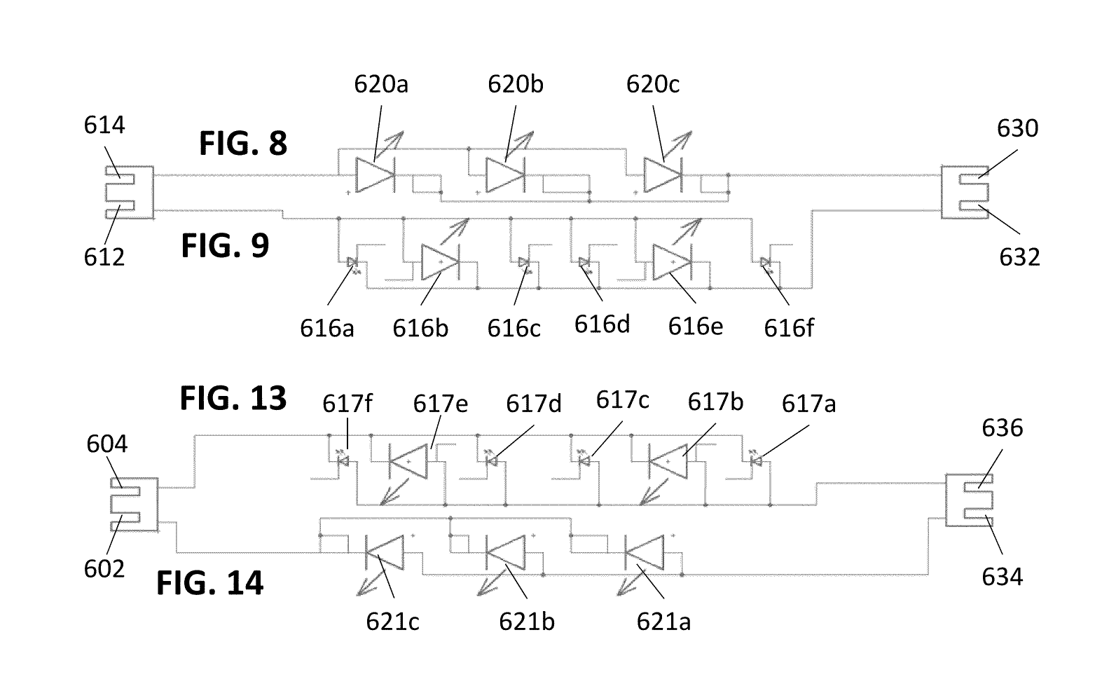

FIG. 8 depicts a wiring schematic for the string of amber LED elements 620a, 620b, 620c. The three amber LED elements 620a, 620b, 620c, are connected in parallel and are driven by a voltage supplied across the amber in jumper 614 and the amber out jumper 630.

FIG. 9 depicts a wiring schematic for the upper string of blue LED elements 616a, 616b, 616c, 616d, 616e, 616f. The six blue LED elements 616a, 616b, 616c, 616d, 616e, 616f, are connected in parallel and are driven by a voltage supplied across the blue in jumper 612 and the blue out jumper 632.

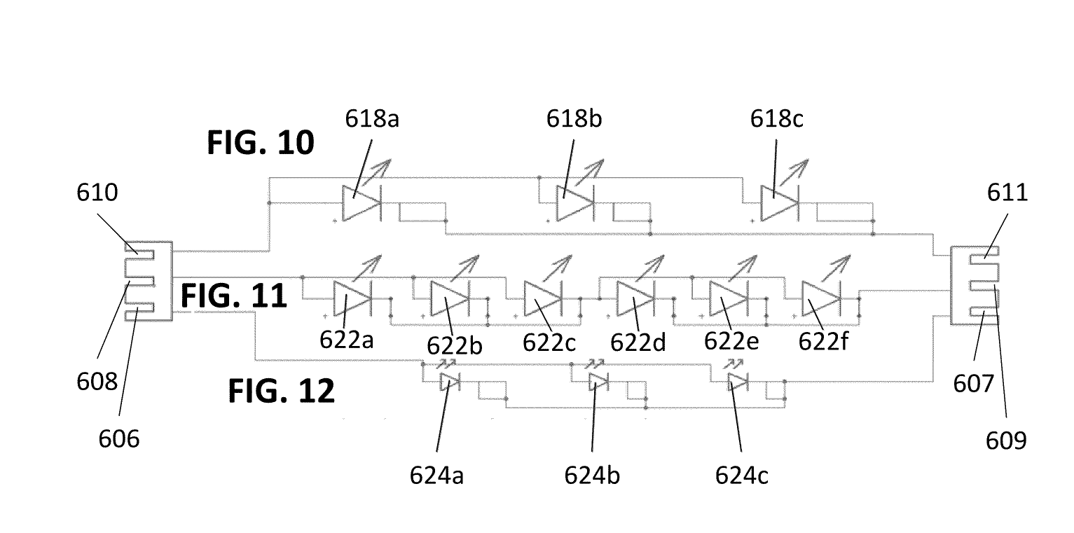

FIG. 10 depicts a wiring schematic for the string of red LED elements 618a, 618b, 616c. The three red LED elements 618a, 618b, 618c are connected in parallel and are driven by a voltage supplied across the red in jumper 610 and the red out jumper 611.

FIG. 11 depicts a wiring schematic for the string white LED elements 622a, 622b, 622c, 622d, 622e, 622f. The six white LED elements 622a, 622b, 622c, 622d, 622e, 622f, are connected in a combination of series and parallel and are driven by a voltage supplied across the white in jumper 608 and the white out jumper 609. White LED elements 622a, 622b, and 622c are driven in parallel, and white LED elements 622d, 622e, and 622f are driven in parallel. The group of white LED elements 622a, 622b, and 622c are driven in series with the group of white LED elements 622d, 622e, and 622f.

FIG. 12 depicts a wiring schematic for the string of UV LED elements 624a, 624b, 624c. The three UV LED elements 624a, 624b, 624c, are connected in parallel and are driven by a voltage supplied across the UV in jumper 606 and the UV out jumper 607.

FIG. 13 depicts a wiring schematic for the string of blue LED elements 617a, 617b, 617c, 617d, 617e, 617f. The six blue LED elements 617a, 617b, 617c, 617d, 617e, 617f, are connected in parallel and are driven by a voltage supplied across the second blue in jumper 636 and the blue return jumper 604.

FIG. 14 depicts a wiring schematic for the lower string of amber LED elements 621a, 621b, 621c. The three amber LED elements 621a, 621b, 621c, are connected in parallel and are driven by a voltage supplied across the second amber in jumper 634 and the amber return jumper 602. The combination of parallel and series wiring and the use of strings of similar LED elements is particularly beneficial for designing a modular LED lighting system. This architecture has numerous benefits over prior lighting systems.

First, the use of multiple independent LED strings on each LED light board 600 in a given lighting system allows the system to produce light of a user chosen SPD by varying the intensity of the light produced by each LED light string. This operability allows the lighting system to mimic any natural or artificial SPD. Compared with prior art systems which power multiple types of LED element on a single channel, the isolation of a single type of LED element in a single string gives greater control over the SPD. Particularly in the aquarium lighting unit 100, the use of LED strings permits adjustment of the SPD to match the SPD that would naturally occur at a given depth.

Second the use of LED strings permits a lighting system to have a uniform SPD throughout the light footprint. In the preferred embodiment, the LED strings are oriented in the elongated direction of the elongated member 214. As a result the SPD is substantially the same along the length of the lighting module 112. Additionally, the preferred embodiment uses the upper and lower amber LED strings 650, 662 and the upper and lower blue LED strings 652, 660 on opposite sides of the LED light board 600. This creates a SPD that is also substantially uniform in a direction perpendicular to the elongated direction of the elongated member 214. The combination of these design features facilitates the production of a light footprint with a uniform SPD. This is a desirable attribute of individual lighting modules of a very large lighting array.

The LED light board 600 is designed to be easily chained together with additional LED light boards 600. A single LED light board 600 can be powered by providing a voltage and current across the amber return jumper 602 and the amber in jumper 614 and providing an electrical connection between the amber out jumper 630 and the second amber in jumper 634, then providing a voltage and current across the blue return jumper 604 and the blue in jumper 612 and providing an electrical connection between the blue out jumper 632 and the second blue in jumper 636, then providing a voltage and current across the UV in jumper 606 and the UV out jumper 607, then providing a voltage and current across the red in jumper 610 and the red out jumper 611, then providing a voltage and current across the white in jumper 608 and the white out jumper 609. In the preferred embodiment the upper and lower blue LED strings 652, 660 are driven by the same LED driver and the upper and lower amber LED strings 650, 662 are driven by the same LED driver. The upper and lower blue LED strings 652, 660 are driven together by providing an electrical connection between the blue out jumper 632 and the second blue in jumper 363. A voltage is then provided across the blue in jumper 612 and the blue return jumper 604. The upper and lower amber LED strings 650, 662 are driven together by providing an electrical connection between the amber out jumper 630 and the second amber in jumper 634. A voltage is then provided across the amber in jumper 614 and the amber return jumper 602. In other configurations, multiple LED strings of the same color LEDs may be driven by different LED drivers.

The architecture described for a single LED light board 600 is scalable to any number of LED light boards 600. When increasing the number of LED light boards 600 used in a light fixture, a practitioner can electrically connect two LED light boards 600 in series. To electrically connect two LED light boards 600, a practitioner must electrically connect the amber out jumper 630 on a first board to the amber in jumper 614 on a second board with a jumper wire; electrically connect the blue out jumper 632 on the first board to the blue in jumper 612 on the second board with a jumper wire; electrically connect the red out jumper 611 on the first board to the red in jumper 610 on the second board with a jumper wire; electrically connect the white out jumper 609 on the first board to the white in jumper 608 on the second board with a jumper wire; electrically connect the UV out jumper 607 on the first board to the UV in jumper 606 on the second board with a jumper wire; electrically connect the second blue in jumper 636 on the first board to the blue return jumper 604 on the second board with a jumper wire; electrically connect the second amber in jumper 634 on the first board to the amber return jumper 602 on the second board with a jumper wire. The two LED light boards 600 can then be powered in the same manner as a single LED board 600. This process can be repeated to connect one of the LED boards 600 that is at one of the two ends of a chain of LED light boards to another LED board.

As one skilled in the art would appreciate, the voltage and current which must be supplied by the lighting system to the plurality of LED light boards 600 will increase with each additional LED light board 600 added to the string of LED light boards 600. A limiting factor will be the voltage limit of the LED drivers 1202, 1204, 1206, 1208, 1210. Each of the lighting modules 112 includes four LED light boards 600 connected in series in the manner described above. In the illustrated embodiment, each of the LED drivers is capable of driving a maximum of six LED light boards 600 connected in series. However, the number of LED light boards connected in a particular embodiment may vary depending upon the needs of the lighting system and drivers can be adapted to driver a greater or lesser number of LED light cards as required by a particular application.

In operation, the preferred configuration of the LED light board 600 provides numerous advancements over the prior art. In some embodiments these advancements make the LED light board well suited for use in very large arrays of LED lights. First, each LED light board 600 is modular in nature. Each LED light board 600 may be powered independently or wired in series with another LED light board 600. The light output of a lighting module 112 can be increased easily by increasing the number of LED light boards 600 in the module and lengthening the elongated member 214 to accommodate the increased number of LED light boards 600.

Second, each LED light board 600 is designed with heavy copper traces. In a very large array, the maximum amount of LED light elements that can be driven by a LED driver will depend upon the supply voltage of the LED driver, the number of LED light elements and the resistance in the circuit linking the LED driver and the LED light elements. The LED board 600 is built with heavy copper traces to reduce the resistance in each trace and thus the voltage drop across each LED light board 600. Using heavy copper traces maximizes the number of LED light boards 600 that a given LED driver can power.

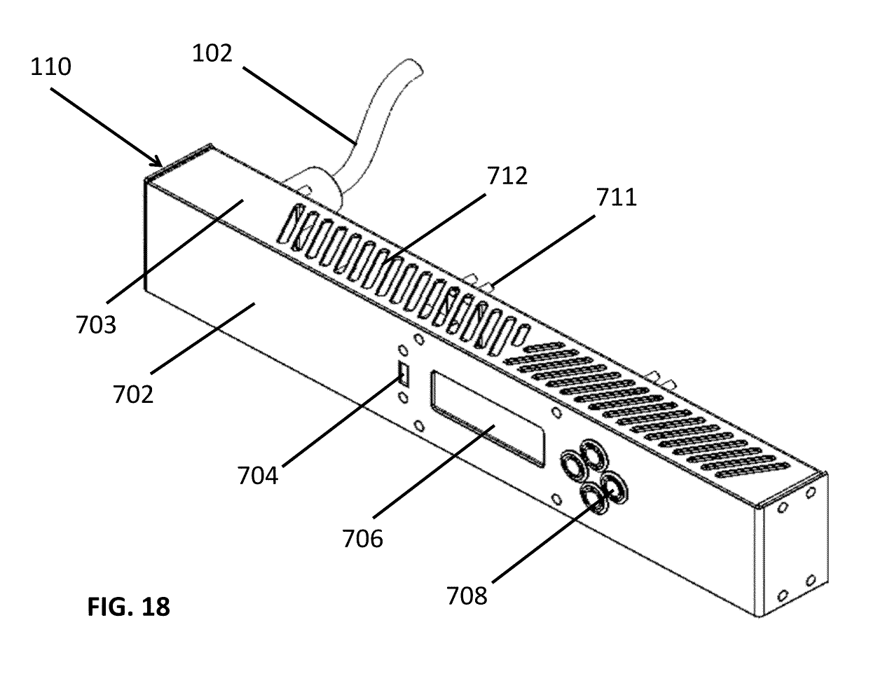

FIG. 18 shows an exemplary embodiment of an electronics end box adapted to include a user interface system. The user interface end box 110 comprises a plurality of user interface end box ventilation slots 712, a plurality of user interface controls 708, a plurality of fasteners 710, a plurality of self-tapping fasteners 711, a user interface display 706, a USB drive 704, a faceplate 702 and a backing plate 703.

The faceplate 702 and backing plate 703 are preferably formed out of stamped and folded steel sheet metal. However, a variety of materials would be suitable for the producing the faceplate 702 and the backing plate 703, including various plastics or other metals. The faceplate 702 and backing plate 703 are secured to each other by fasteners 710. The backing plate 703 is a substantially U-shaped piece of folded sheet metal with a plurality of cutouts that each substantially match the cross sectional profile of the region defined by the top surface 322 of the elongated member 214, the upper sidewalls 326 of the elongated member 214 and the top panel 201 (when the top panel is fixed to the elongated member 214). The backing plate 703 mounts to the plurality of lighting modules 112 with a plurality of self-tapping fasteners 711 which are placed through holes (not shown) in the backing plate 703 and threaded into the plurality of end box mounting channels 312.

The USB drive 704, the user interface display 706 and the plurality of user interface controls 708 allow a user of the aquarium lighting unit 100 to interface with a microcontroller 1110 to control the operation of the aquarium lighting unit 100. In the preferred embodiment the USB drive 704, user interface displace 706 and the plurality of user interface controls 708 are located on the user interface end box 110, however in various embodiments they may be located separate from the user interface end box 110.

In operation, the user interface end box 110 receives 48V DC electricity via the power cable 102. The power is then routed via a plurality of electrical connections to the various parts of the invention that require electricity. The USB drive 704 allows a user to update the software running on the microcontroller 1110. Such updates may include new lighting profiles.

For example, it may be desirable to vary the intensity of the plurality of LED elements contained on the LED light board 600 over a 24-hour or 28-day period to mimic solar or lunar cycles. Because each LED string contained on each LED light board 600 is driven independently in the preferred embodiment, the microcontroller 1110 can finely adjust the spectrum of light produced by the aquarium lighting unit 100. The plurality of user interface controls 708 enable a user to cycle through information about the lighting system, as displayed on the user interface display 706. The user may also select from a variety of lighting profiles preprogramed on the microcontroller 1110.

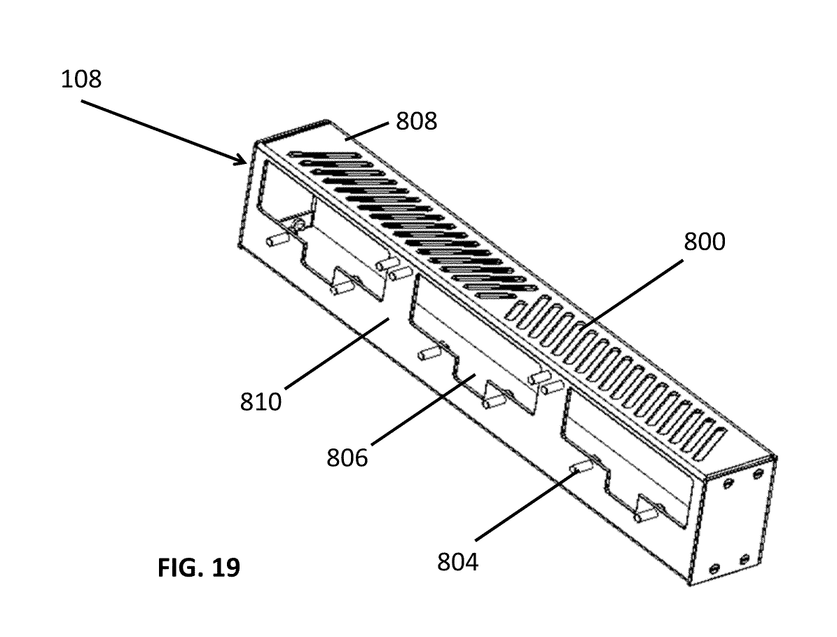

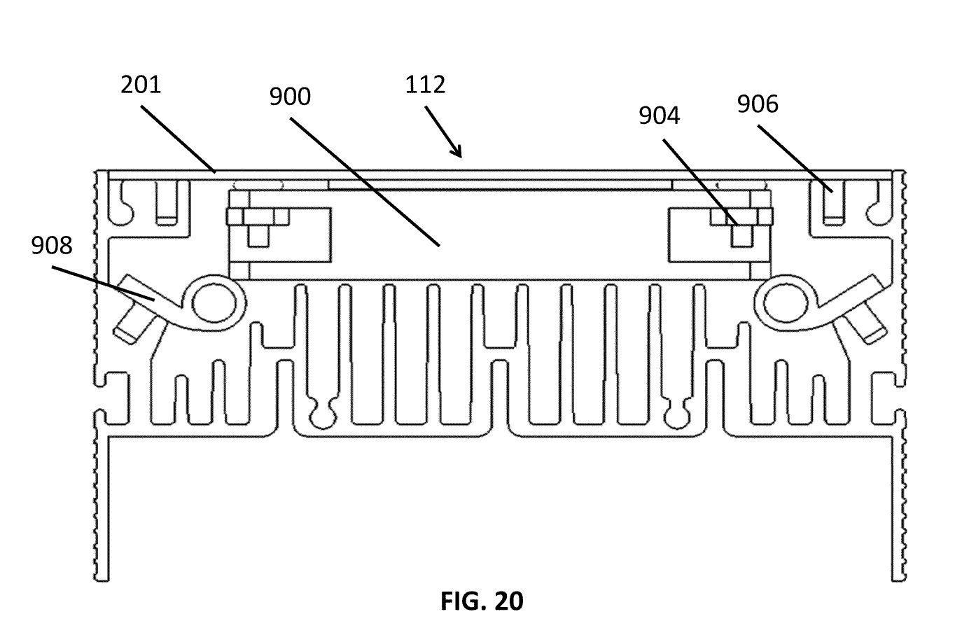

FIG. 19 shows an exemplary embodiment of an end box 108. The end box 108 comprises a plurality of end box ventilation slots 800, cutouts 806, a faceplate 808, a backing plate 810 self-tapping fasteners 804 and mechanical fasteners 802. The end box 108 is preferably constructed from stamped and folded steel sheet metal; however, various embodiments of the invention may use other materials such as plastic or other metals. The faceplate 808 and the backing plate 810 are attached to one other with the use of mechanical fasteners such as bolts and nuts. The backing plate 810 is a substantially U-shaped piece of folded sheet metal with a plurality of cutouts 806 that each substantially match the cross sectional profile of the region defined by the top surface 322 of the elongated member 214, the upper side walls 326 of the elongated member 214 and the top panel 201 (when the top panel is fixed to the elongated member 214). The backing plate 810 mounts to the plurality of lighting modules 112 with a plurality of self-tapping fasteners 804, which are placed through holes (not shown) in the backing plate 810 and threaded into the plurality of end box mounting channels 312.

FIG. 20 is a cross section view of an exemplary embodiment of a sub-assembly of a lighting module 112. FIG. 20 depicts the sub-assembly of a lighting module 112 assembled with a fan 900, top panel 201, cable guides 908 and fasteners 904. The top panel 201 attaches to the elongated member 214 with a plurality of self-tapping fasteners 906 which are threaded into the top panel mounting channels 306. The illustrated embodiment of the lighting module 112 uses two fans 900 per lighting module 112. The fans 900 are mounted to the top panel 201 with a plurality of mechanical fastener 904 which are places through the plurality of fan mounting holes 208 through the top panel 201. The fan mounting holes 208 align the plurality of fans 900 with the plurality of fan outlet vents 200.

In operation, the fans 900 force air out of the fan outlet vents 200 and thus, pull air in from various openings in the lighting module 112, including the top panel ventilation slots 206, the user interface end box ventilation slots 712 and the end box ventilation slots 800. The illustrated embodiment uses two 24 cfm ultra quiet fans per 45″ section of lighting module 112.

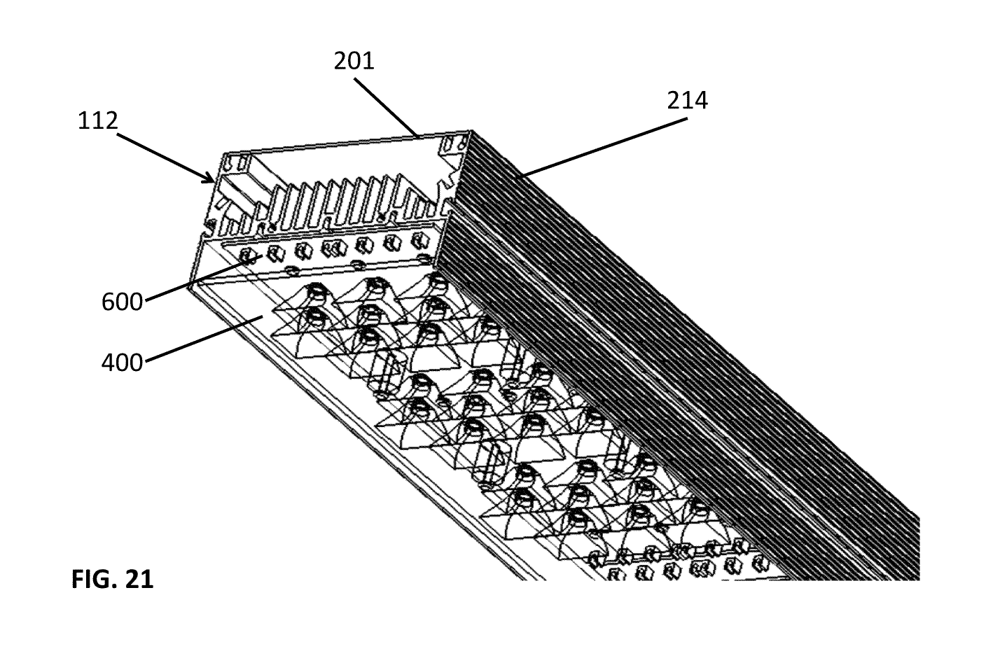

FIG. 21 shows the lighting module 112 including a TIR lens array 400, a LED light board 600, an elongated member 214 and a top panel 201. The elongated member 214 provides a chassis for the lighting module 112. The LED light board 600 is mounted to the bottom surface 324 of the elongated member 214. The TIR lens array 400 is mounted parallel to the bottom surface 324 and spaced from the LED light board 600 with a plurality of lens array spacers 502. Each total internal reflection lens 408 is located immediately adjacent to one of the plurality of LED elements located on the LED light board 600.

Additionally, FIG. 21 highlights the modular nature of certain embodiments of the invention. The lighting module 112 depicted in FIG. 10 can be modified to increase the size of the area illuminated by a lighting system by increasing the length of the elongated member 214, increasing the number of LED light boards 600, adding an additional TIR lens array 400 for each additional LED light board 600, connecting the plurality of LED light boards 600 as described previously, providing additional fans 900 as needed to keep the LED light boards 600 cool and adjusting the voltage and current supplied to the LED light boards 600.

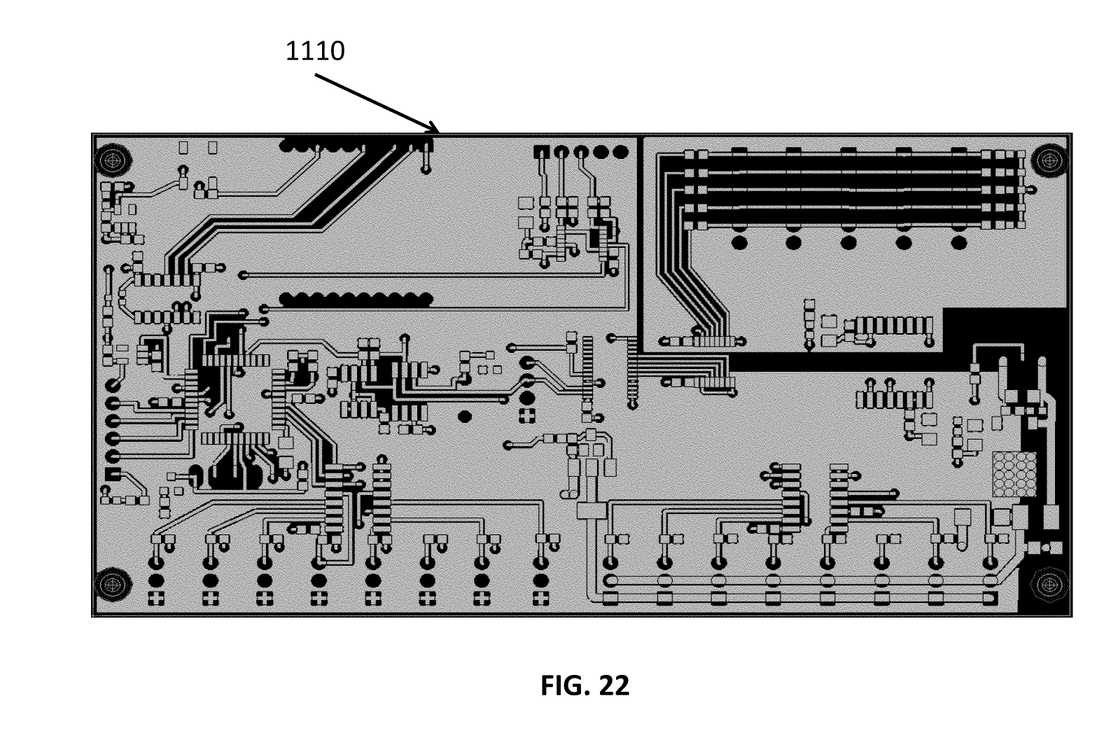

FIG. 22 shows an embodiment of a microcontroller 1110 as used in the aquarium lighting unit 100. The aquarium lighting unit 100 uses one microcontroller 1110 for controlling the operation of the plurality of lighting modules 112, the plurality of LED driver boards 1200, the user interface display 706, and the user interface controls 708. The USB driver 704 can be used to update the firmware on the microcontroller 1110 and to monitor the operation of the aquarium lighting unit 100 via a remote processor. The microcontroller 1110 mounts to the top panel 201 of one of the lighting modules 112.

The microcontroller 1110 is preprogramed with a variety of lighting cycles that may be selected by a user. These preprogramed lighting cycles include the ability to mimic the lighting conditions of solar and lunar cycles on a 365-day cycle. Additionally, a user may select a solar and lunar cycle modeled after the solar and lunar cycles that naturally occur at any particular region on the globe. Further, a user may direct the microcontroller 1110 to mimic the SPD that occurs at a particular depth. This functionality is beneficial for artificially growing coral because the SPD of sunlight in water changes dramatically as the distance from the surface increases and many coral grow at depths greater than those found in aquariums. With the ability to replicate the natural lighting cycle for any location on the globe and then to replicate the SPD of sunlight at a given depth at that location, the microcontroller 1110 allows a user to very closely match the natural growing conditions for any type of coral.

The microcontroller 1110 also allows individual control of the maximum intensity of light produced by the upper and lower amber LED strings 650, 662, upper and lower blue LED strings 652, 660, white LED string 656, red LED string 654, and UV LED string 658. Additionally, the user can see the anticipated SPD from a given lighting cycle and adjust the intensity of the various LED strings to better match the anticipated SPD to the CRAVE spectra for certain species of plants or coral.

In order to control the lighting profile of the aquarium lighting unit 100, the microcontroller 1110 sends a plurality of pulse width modulation (PWM) signals to the plurality of LED drivers 1202, 1204, 1206, 1208, 1210. Depending upon the nature of the PWM signal sent by the microcontroller to each LED driver, each LED driver can vary the intensity of light produced by each string of the LED lights.

Additionally, the microcontroller 1110 controls the operation of the fans 900, and thermocouples (not shown, but which may be located in any location within the thermocouple mounting channel 300). By monitoring the temperature of the elongated member 214 at the thermocouple mounting channel 300, the microcontroller may adjust the operation of the fans 900 to ensure sufficient cooling of the aquarium lighting unit 100. Also, should a fan 900 fail, or should the system be overheating, the microcontroller is capable of terminating the operation of the aquarium lighting unit 100 and notifying the user via the user interface display 706.

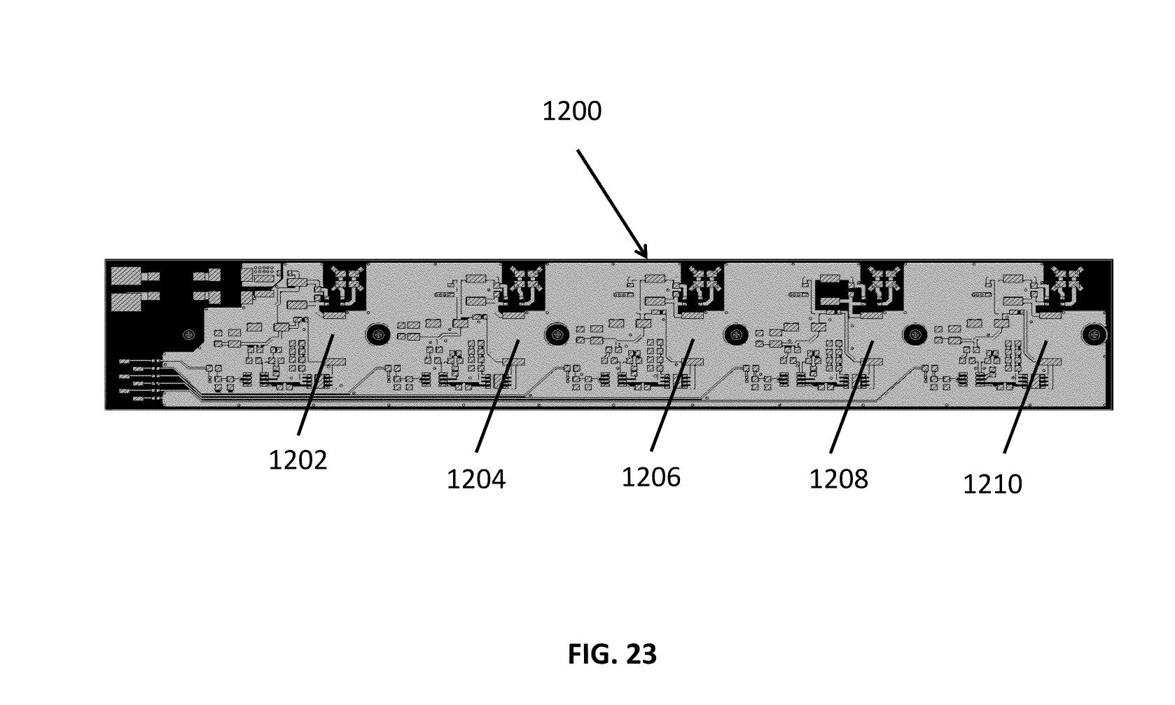

FIG. 23 shows an exemplary embodiment of a LED driver board 1200. In the preferred embodiment, a single LED driver board 1200 is used to drive the LED light boards 600 in each lighting module 112. Thus the aquarium lighting unit 100 contains three LED driver boards 1200. The LED driver board 1200 mounts to the top panel 201 with mechanical fasteners positioned through the LED driver mounting holes 204. The LED driver board 1200 contains five LED drivers, in the preferred embodiment there is a UV LED driver 1202 for powering the UV LED string 658, a white LED driver for powering the white LED string 656, an amber LED driver 1206 for powering both the lower amber LED string 662 and the upper amber LED string 650, a blue LED driver 1208 for powering both the upper blue LED string 652 and the lower blue LED string 660, and a red LED driver 1210 for powering the red LED string 654.

However, it should be noted that the same architecture as used by the LED driver boards 1200 and LED light boards 600 could be used in any lighting system that drives LED light boards 600 containing a plurality of LED light strings and plurality of LED elements. The number of LED drivers need not be the same as the number LED light strings. Such as in the aquarium lighting unit 100 wherein five LED drivers 1202, 1204, 1206, 1208, 1210 drive seven LED light strings 650, 652, 654, 656, 658, 660, 662.

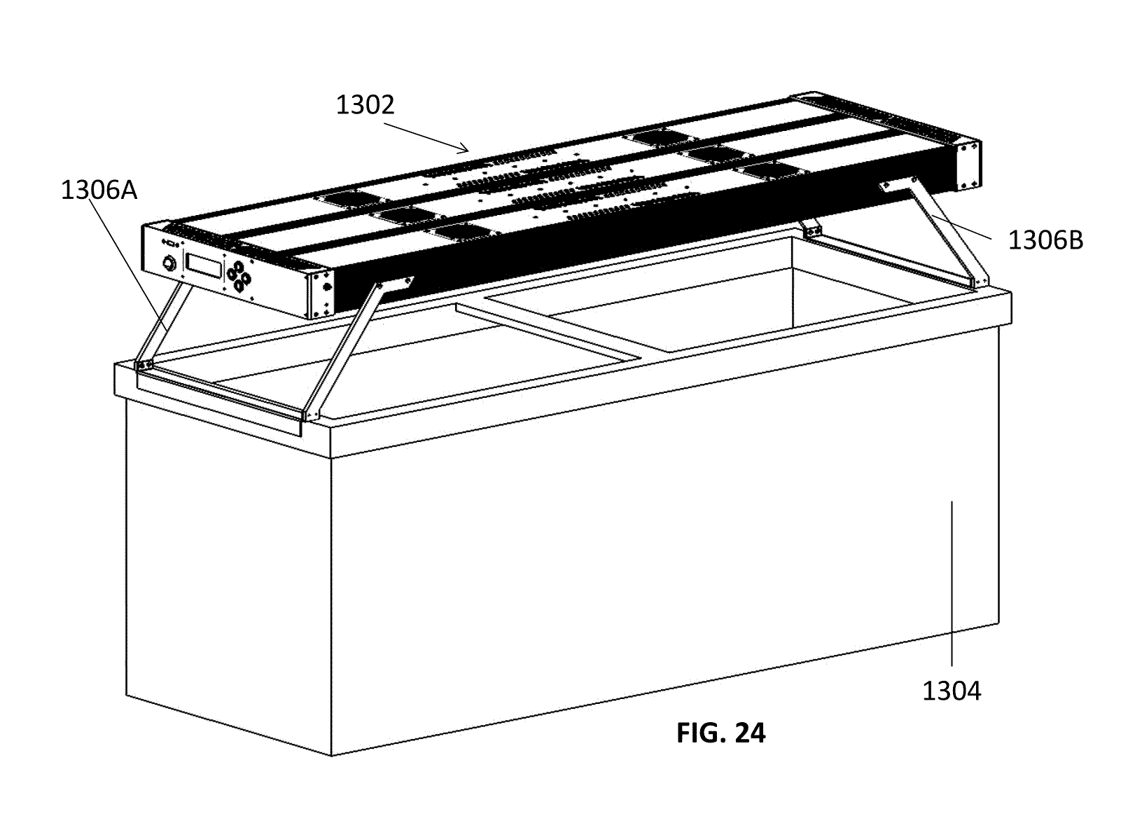

With reference to FIG. 24, a second embodiment of an aquarium lighting unit 1300 (hereinafter referred to as “lighting unit 1300”) is described. The lighting unit 1300 includes (a) a lighting fixture 1302 for producing light suitable for promoting the growth of plants and/or animals resident in an aquarium 1304 and (b) legs 1306A, 1306B that support the lighting fixture 1032 approximately 9 in. (approx. 23 cm) above the water surface of the aquarium 1304 (typically, the water surface is within 1-2 in (2.5-5.0 cm) of the top of the aquarium. Supporting the lighting fixture 1302 at this distance results in a very even distribution of light over substantially the entire water surface. As such, plants and/or animals can be located substantially anywhere in the aquarium and receive a substantially equal distribution of light (shadowing effects aside).

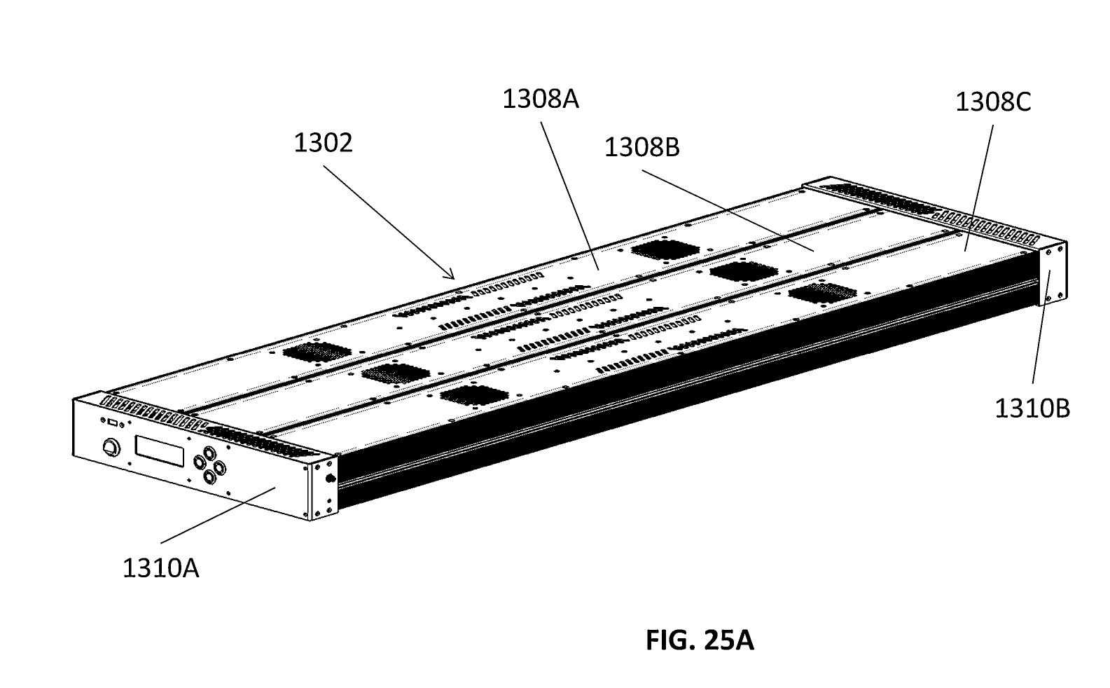

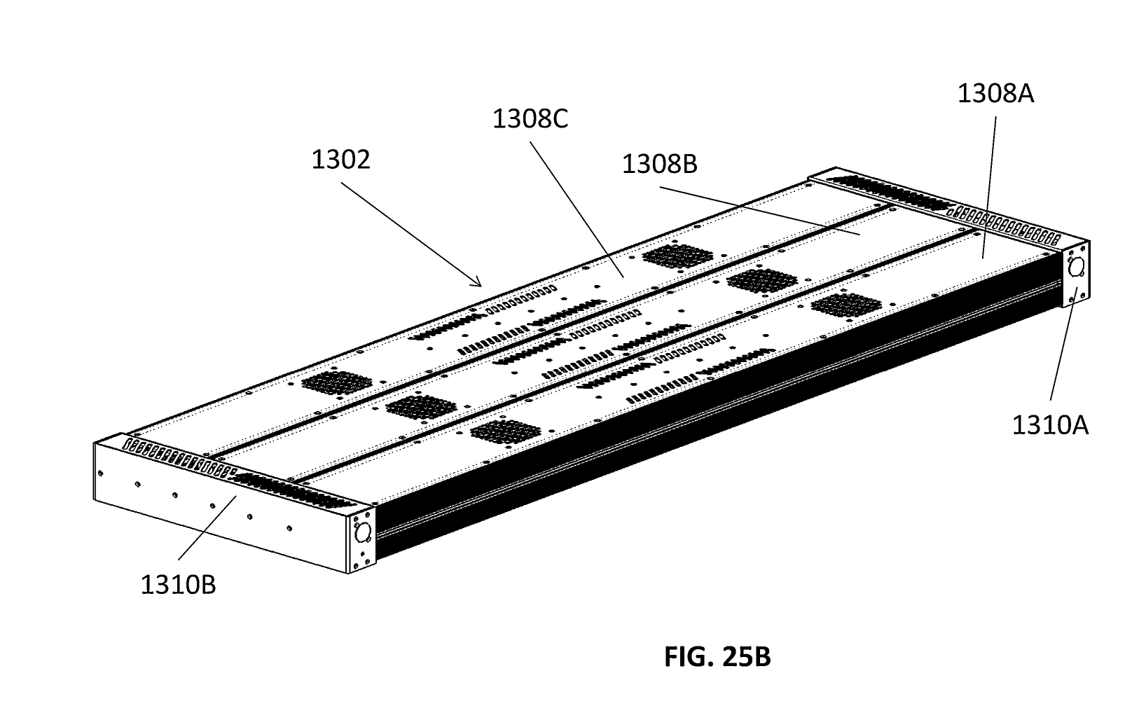

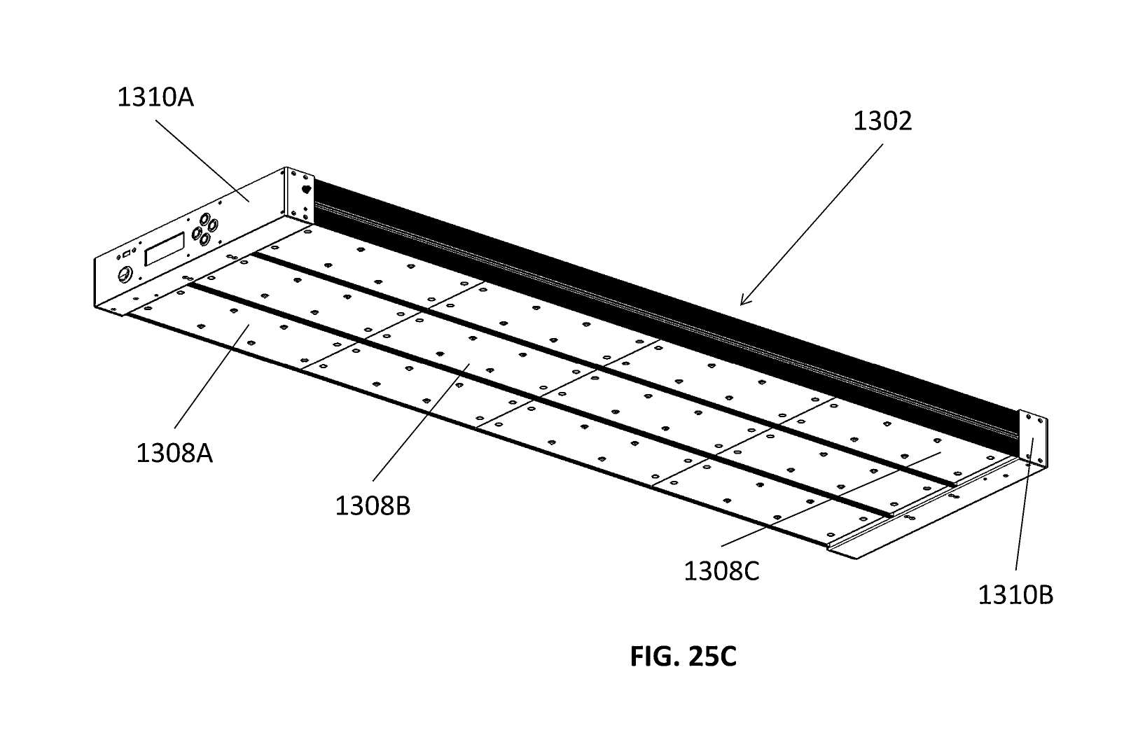

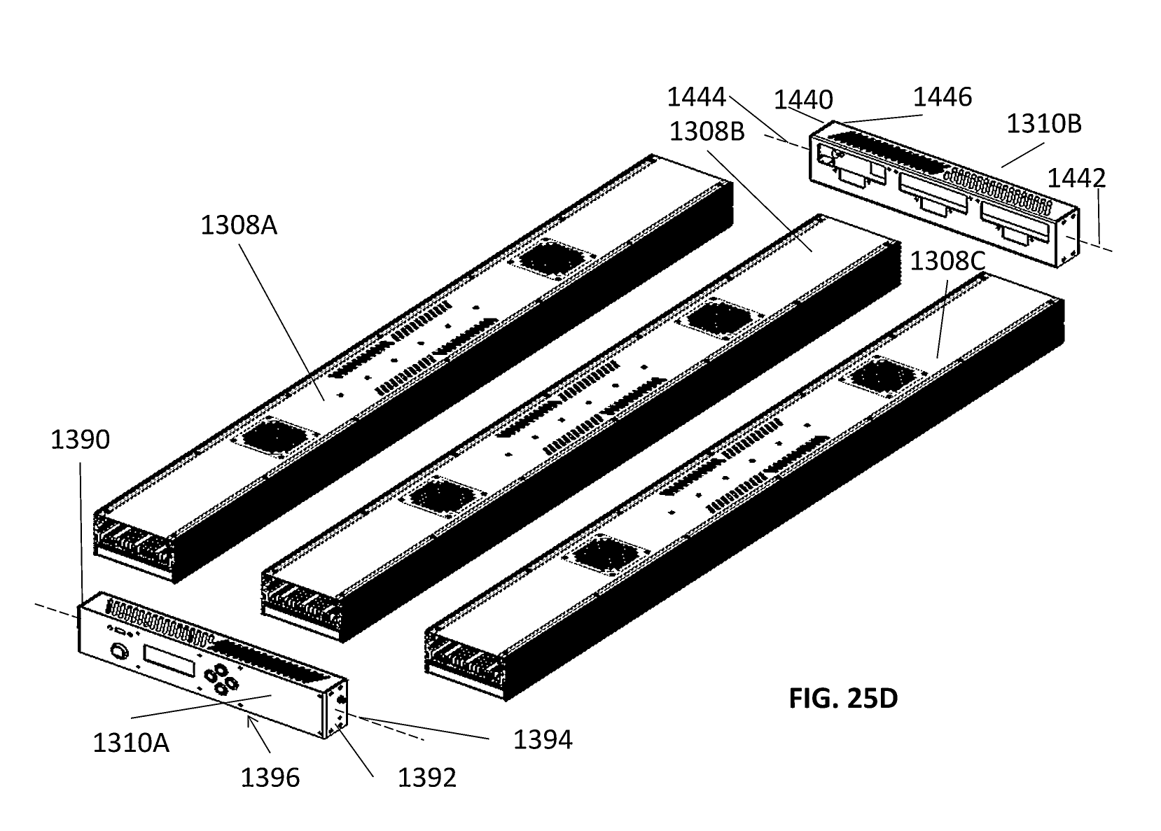

With reference to FIGS. 25A-25D, the lighting fixture 1302 is comprised of (a) three LED lighting modules 1308A-1308C that are each capable of producing light of one color or multiple colors and (b) end modules 1310A-1310B that each rigidly engage the LED lighting module 1308A-1308C to form the lighting fixture 1302.

The LED lighting modules 1308A-1308C are substantially identical to one another with respect to the components that comprise the module and the location of the components to one another. Consequently, the features common to LED lighting modules 1308A-1308C are described with respect to LED lighting module 1308A and with the understanding that these common features are equally applicable to LED lighting module 1308B, 1308C. Features of the LED lighting module 1308A that may differ from LED lighting module 1308B, 1308C are identified as such.

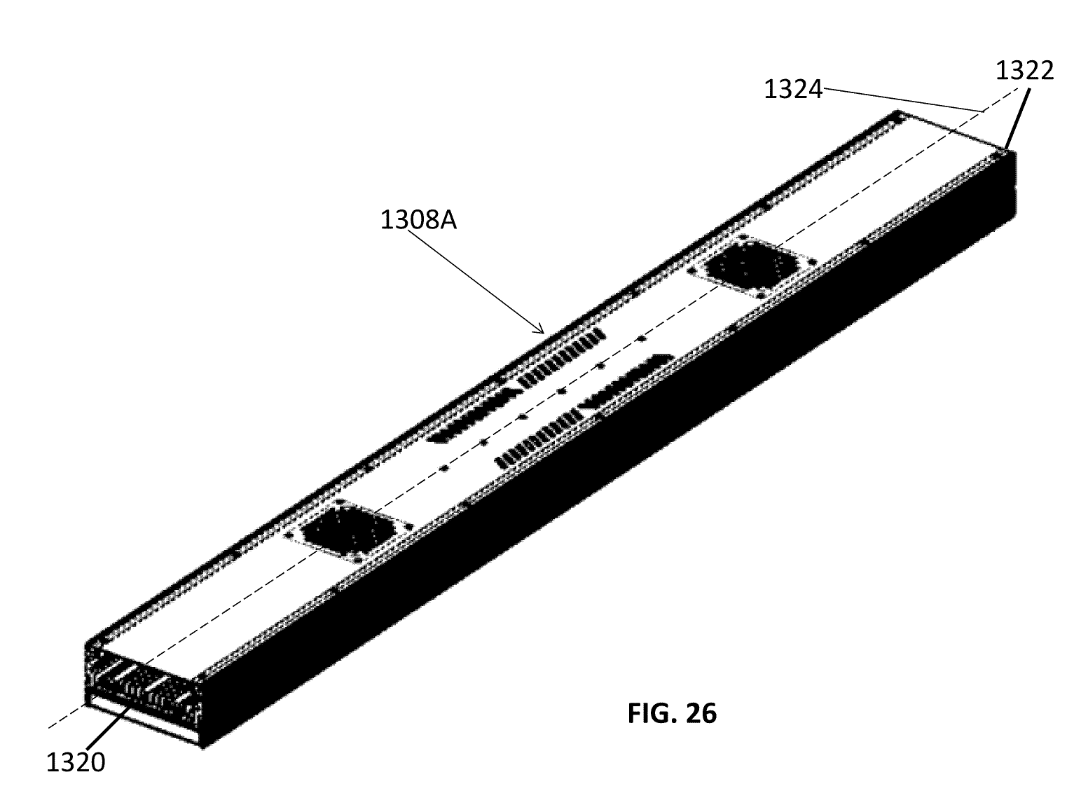

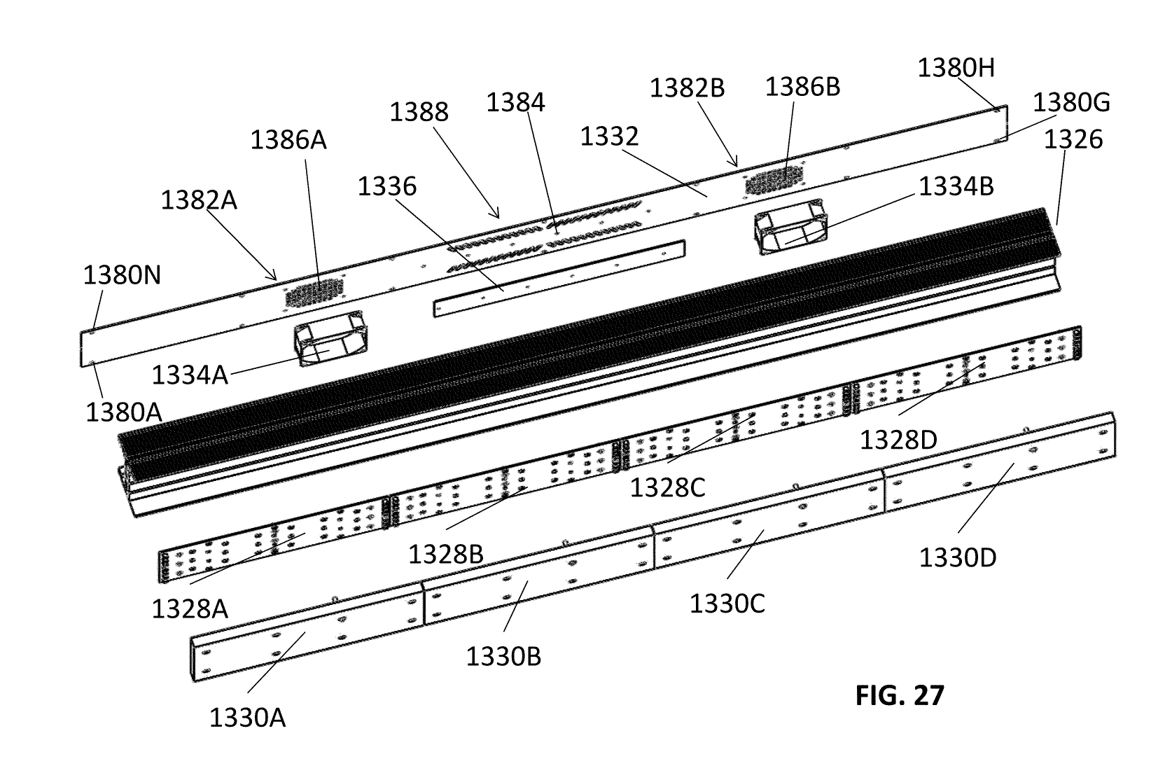

With reference to FIGS. 26 and 27, the LED lighting module 1308A is comprised of an elongated member 1326, four LED light boards 1328A-1328D, four TIR lens array structures 1330A-1330D, a top plate 1332, and fans 1334A, 1334B. Also associated with the lighting module 1308A is an LED driver board 1336 that supports electronic that are used to drive the LEDs associated with the four LED light boards 1328A-1328D. An example of an LED driver boards 1336 is the LED driver board 1200 illustrated in FIG. 23. In certain embodiments, the driver board that is used to drive the LEDs associated with a particular LED lighting module may be located in another LED lighting module or an end module associated with the lighting fixture.

Before describing specific features of the components of the LED light module 1308A, the features of these components that facilitate the scaling of LED light modules to have greater or lesser lengths than LED light module 1308A are described. The LED lighting module 1308A is a column-like or bar-like structure that extends from a first open end 1320 to a second open end 1322, has a longitudinal axis 1324, and a substantially constant rectangular cross-sectional profile along the entire length of the module from the first open end 1320 to the second open end 1322. Each of the elongated member 1326, four LED light boards 1328A-1328D, four TIR lens array structures 1330A-1330D, and top plate 1332 extends substantially from the first open end 1320 to the second open end 1322 of the LED lighting module 1308A. The elongated member 1326 and the top plate 1332 each have a substantially constant cross-section between the first and second open ends 1320, 1322. These substantially constant cross-sections facilitate scaling of the lengths of the elongated member 1326 and the top plate 1332 to realize LED lighting modules with greater or lesser lengths than LED lighting module 1308A. Similarly, the four LED light boards 1328A-1328D and the four TIR lens array structures 1330A-1330D have cross-sections between the first and second open ends 1320, 1322, that vary but do not preclude scaling to realize an LED lighting module with a length greater than or less than the LED lighting module 130A.

In the illustrated embodiment, the scaling of the length of an LED lighting module is a function of the length of the LED light boards. Each of the LED light boards 1328A-1328D has substantially the same length, namely, 11.125 inches (28.26 cm). This length allows the length of the LED lighting module to be scaled to lengths that accommodate many common aquarium lengths. Typically, the length of an LED lighting module is substantially equal to the cumulative lengths of the LED light boards supported by the module in the illustrated end-to-end fashion. However, if needed or desired, the length of an LED lighting module can be greater than this cumulative length. However, in this case, there will be some space that is not occupied by an LED light board. Further, to accommodate aquariums with uncommon or unstandard lengths, one or more LED light boards of one length can be coupled with a “filler” LED light board with a length that accommodates the difference between the length of the tank and the cumulative lengths of the one or more LED light boards of one length.

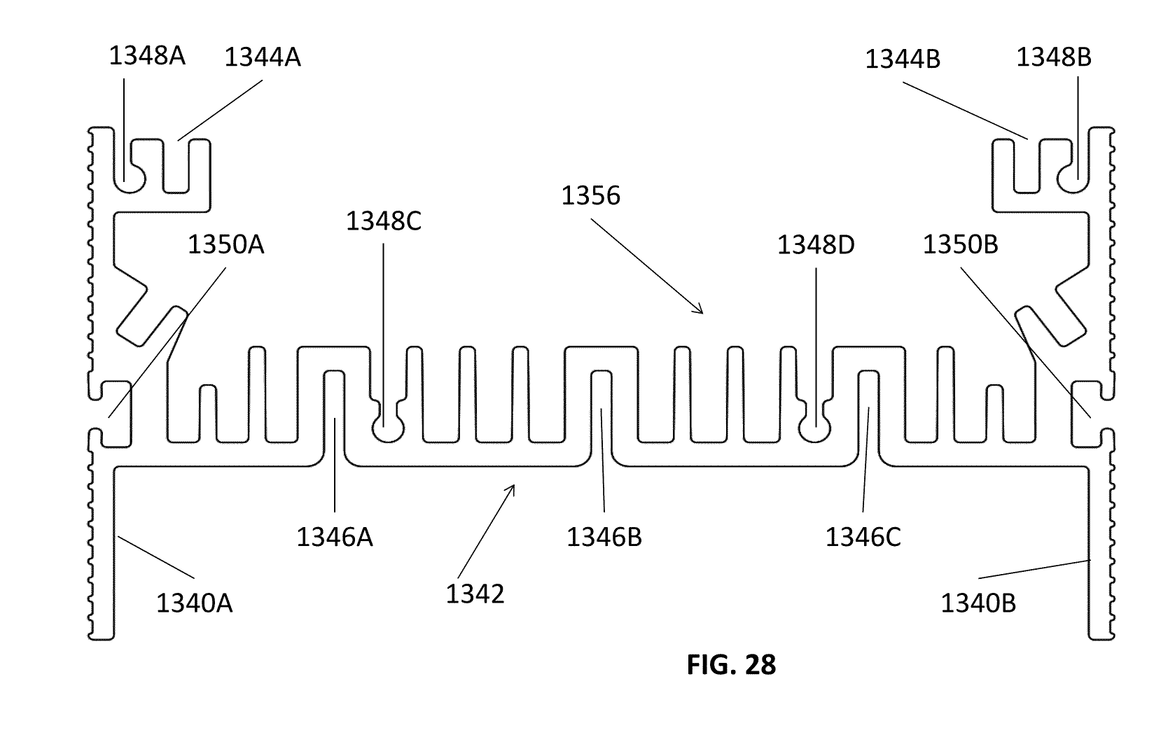

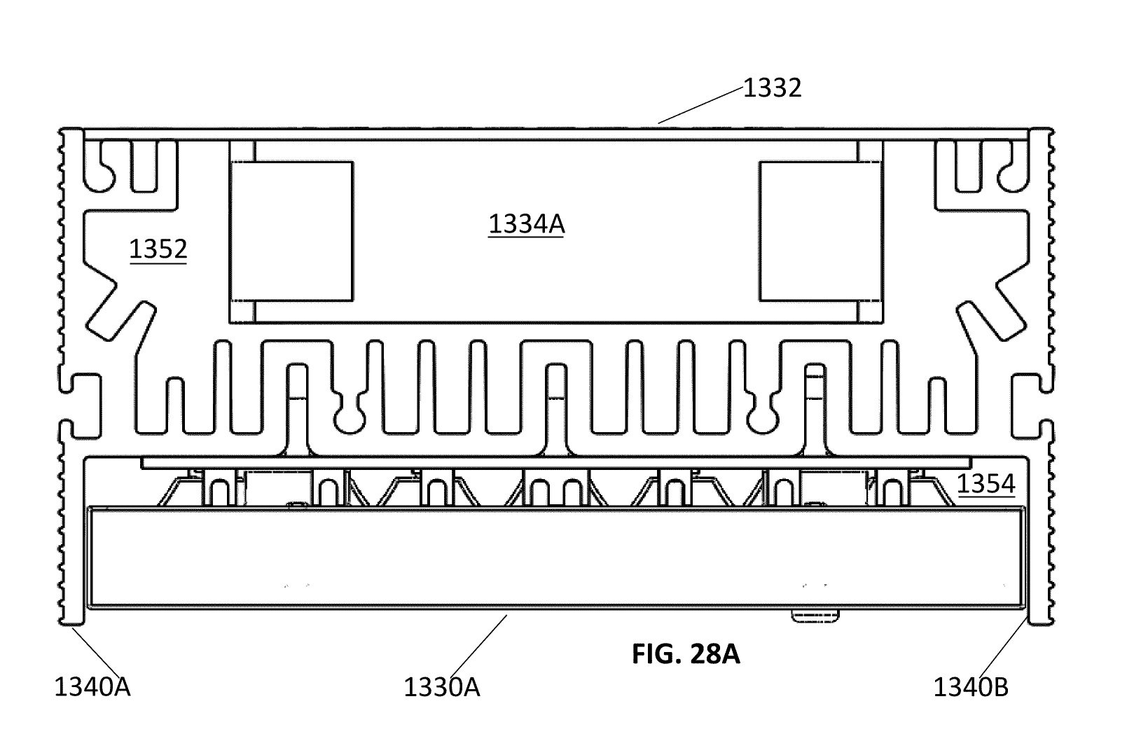

With reference to FIG. 28, the elongated member 1326 serves a number of purposes, including defining a portion of the rectangular cross-section of the lighting module 1306A, providing a mounting structure, defining portions of two enclosures associated with the lighting module 1308A, providing a heat sink for heat produced by the operation of the LEDs. To elaborate, the elongated member 1326 has a generally H-shaped cross-sectional shape with two side members 1340A, 1340B that are substantially parallel to one another and a cross-member 1342 connecting the two side members to one another. With respect to the elongated member 1326 defining a portion of the rectangular cross-section of the light module, the two side members 1340A, 1340B form the lateral sides of the lighting module 1308A.

With respect to the elongated member 1326 serving as a mounting structure, the elongated member 1326 defines channels 1344A, 1344B for receiving thread-cutting fasteners that connect the top plate 1332 to the elongated member 1326; channels 1346A, 1346C for receiving thread-cutting fasteners that connect each of the TIR lens array structures 1330A-1330D and each of the corresponding LED light boards 1328A-1328D to the elongated member 1326; channel 1346B for receiving thread-cutting fasteners that connect the LED light boards 1328A-1328D to the elongated member 1326; channels 1348A-D at one end of the elongated member 1326 for receiving thread-cutting fasteners that rigidly engage the elongated member 1326 to end module 1310A; and channels 1348A-1348D at the other end of the elongated member 1326 for receiving thread-cutting fasteners that rigidly engage the elongated member to the end module 1310B. With respect to the connection of the LED light boards 1328A-1328D to the elongated member 1326, the light boards are sandwiched between the TIR lens array structures 1330A-1330D and the elongated member 1326. Channels 1350A, 1350B each cooperate with connectors associated with the ends of both of the legs 1306A, 1306B to connect the legs to the elongated member 1326.

As to the elongated member 1326 defining two enclosures associated with the LED light module 1308A, the top plate 1332, cross member 1342, and portions of the two sides members 1340A, 1340B extending between the top plate 1332 and cross member 1342 define a first enclosed space 1352 that is partially occupied by other elements associated with the LED lighting module 1308A but has substantial unoccupied space through which air can be moved to remove heat associated with the operation of the lighting unit 100 and, particularly, the operation of the LEDs associated with the LED lighting module 1308A. See FIG. 28A. A second enclosed space 1354 is defined by the TIR lens array structures 1330A-1330D, cross member 1342, and portions of the two side members 1340A, 1340B extending between the TIR lens array structures 1330A-1330D and the cross member 1342. See FIG. 28A. The LED light boards 1328A-1328D largely occupy the second enclosed space 1352. To a substantial extent, the elements that form the second enclosed space 1354 provide a substantial barrier to water from the aquarium coming into contact with the LED light boards 1330A-1330D.

With respect to the elongated member 1326 serving as a heat sink structure, the cross member 1342 is thermally engaged with the two side members 1340A, 1340B and with a number of fins 1356 that extend into the first enclosed space 1352. As such, heat produced by the operation of the LEDs associated with the LED light boards 1328A-1328D, (which are in thermal contact with the cross member 1342) can be transferred to the cross-member 1342, side members 1340A, 1340B, and the fins 1356 and dissipated to prevent the LEDs from becoming undesirably hot. The elongated member 1326 is extruded aluminum. Other heat conducting materials can be used for the elongated member 1326 if needed or desired.

With reference to FIG. 27, the LED light boards 1328A-1328D are each substantially the same as the LED light board 600 described with respect to FIGS. 6-14. Further, the LED light boards 1328A-1328D are positioned in an end-to-end fashion with little, if any, gap between adjacent boards. By positioning the boards in this manner, the length of the jumper wires that extend between adjacent boards is reduced and the resistance associated with the jumper wires is reduced relative to jumper wires that extend between boards with greater spacing between the boards. Further, the end-to-end positioning of the LED light boards 1328A-1328D, together with each board having substantially the same layout of LEDs, provides a relatively even distribution of light across the length of the aquarium 1304. Separating the boards from one another would likely lead to an increasing uneven distribution of light across the aquarium.

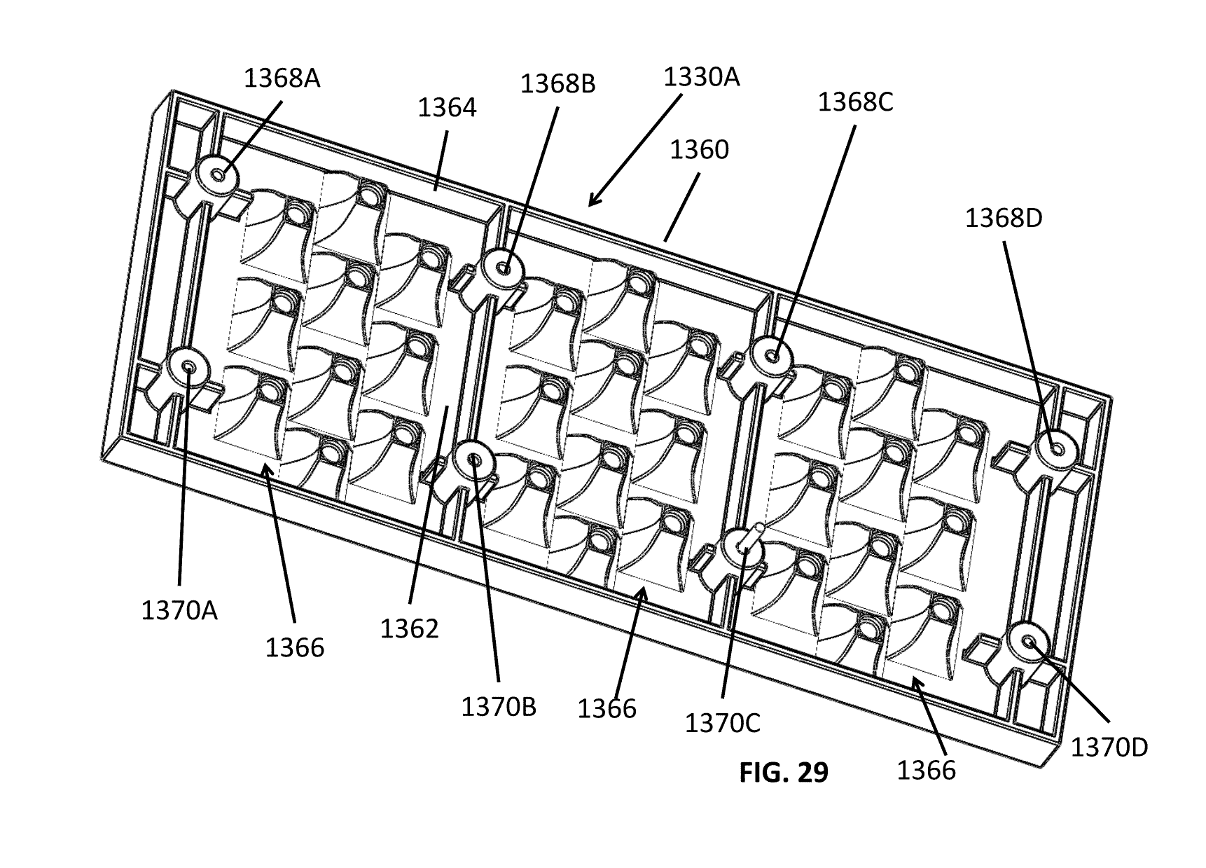

With reference to FIG. 29, the four TIR lens array structures 1330A-1330D are substantially identical to one another. Consequently, TIR lens array structure 1330A is described with the understanding that the description is equally applicable to each of the TIR lens arrays structure 1330B-1330D. The TIR lens array structure 1330A is comprised of a bathtub-like structure 1360 with a base 1362 and a side surface 1364. The bathtub shape reduces deformation/warpage of the structure 1360 during the injection molding process used to manufacture the structure. The lens array structure 1330A also includes an array of TIR lenses 1366 that are supported by the structure 1360. Each lens in the array of TIR lenses is positioned to operatively engage one of the LEDs associated with an LED light board. The TIR lens array structure 1330A also includes a first mounting hole defining structures 1368A-1368D that define holes that correspond with mounting holes in an LED light board and with channel 1346A of the elongated member 1326. Second mounting hole defining structures 1370A-1370D define holes that correspond with mounting holes in an LED light board and with channel 1346C of the elongated member 1326.

With reference to FIG. 27, the top plate 1332 defines a first group of fourteen holes 1380A-1380N disposed around the outer edge of the top plate 1332 (only 1380A, 1380G, 1380H, and 1380N are identified in FIG. 27) that are each positioned and adapted to receive a thread-cutting fastener which engages one of the channels 1344A, 1344B to attach the top plate 1332 to the elongated member 1326. Also defined by the top plate 1332 is a second group of four holes 1382A that are each positioned and adapted to receive a fastener that engages a corresponding thread-locking nut associated with the fan 1334A to attach the fan to the top plate. The top plate 1332 also defines a third group of holes 1382B that are each positioned and adapted to receive a fastener that engages a thread-locking nut associated with the fan 1334B to attach the fan to the top plate. The top plate 1332 defines a fourth group of six holes 1384 that are each positioned and adapted to receive a fastener that engages a corresponding hole associated with the drive board 1336 to attach the drive board to the top plate. Also defined by the top plate 1332 are: (a) fan outlet ports 1386A, 1386B that respectively correspond with the outlet sides of fans 1334A, 1334B when the fans are attached to the top plate and (b) fan inlet ports 1388.

Generally, the fans 1334A, 1334B each have an inlet side that is in communication with the first enclosed space 1352. The fan 1334A has an outlet side that is in communication with the ambient environment via the fan outlet port 1386A. Similarly, the fan 1334B has an outlet side that is in communication with the ambient environment via the fan outlet port 1386B. In operation, the fans 1334A, 1334B each operate to move air from the first enclosed space 1352 that has been warmed due to the operation of the LEDs to the ambient environment via the fan outlet ports 1386A, 1386B and thereby prevent the LEDs from becoming undesirably hot.

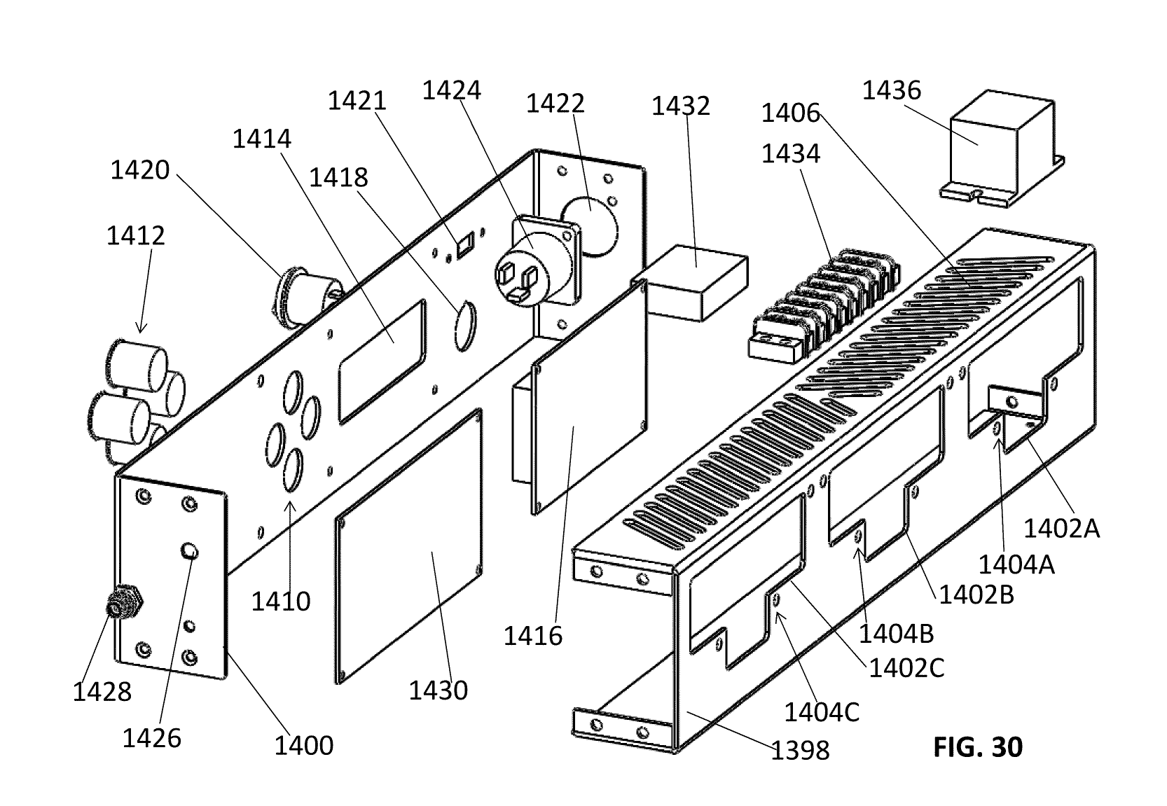

With reference to FIG. 25D, the end module 1310A is a column-like or bar-like structure that extends from a first end 1390 to a second end 1392, has a longitudinal axis 1394, and a substantially constant rectangular cross-sectional profile along the entire length of the module from the first end 1390 to the second end 1392. The end module 1310A includes a housing 1396. With reference to FIG. 30, the housing 1396 is formed from a first U-shaped member 1398 and a second U-shaped member 1400 that are joined to one another with fasteners. The housing 1396 defines an enclosed space that is partially occupied by a number of other components of the end module 1310A. However, a substantial portion of the enclosed space is unoccupied space through which air can be moved to remove heat associated with the operation of the other components located in the enclosed space. The first U-shaped member 1398 defines three lighting module cutouts 1402A-1402C and three groups of four holes 1404A-1404C respectively associated with the cutouts. The first group of four holes 1404A receives threading-cutting fasteners that pass through the holes and engage channels 1348A-1348D at the first open end 1320 of the elongated member 1326 to establish a rigid connection between the lighting module 1308A and the end module 1310A. The second and third groups of four holes 1404B, 1404C respectively receive thread-cutting fasteners that engage the channels 1348A-1348D at the first open end 1320 of the lighting modules 1308B, 1308C to establish rigid connections between the lighting modules and the end module 1310A. Further, these connections establish pathways between the enclosed space of the end module 1310A and the first enclosed spaces 1352 of each of the LED lighting modules 1308A-1308C. The pathways can be used to establish electrical connections (a) between electrical circuitry located within the end module 1310A and the LED lighting modules 1308A-1308C and (b) between electrical circuitry located in the LED lighting modules 1308A-1308C. Further, the pathways can be used to move warm air from the enclosed space of the end module 1310A to the exterior environment. To elaborate, the first U-shaped member 1398 also defines fan inlet ports 1406 that are in communication with the enclosed space of the end module 1310A. As such, when at least one of the fans 1334A, 1334B of at least one of the LED lighting modules 1308A-1308C is in operation, relatively cool ambient air is pulled through the fan inlet ports 1406, through the enclosed space of the end module 1310A where heat from the operation of the electrical components located in the enclosed space is transferred to the air, through the passageway between the end module 1310A and into the first enclosed space 1352 of the relevant lighting module where heat from the operation of the lighting modules LEDs is transferred to the air. The heated air is then transferred to the ambient atmosphere via the relevant one of fan outlet port 138A, 138B. Generally, as the number of the fans associated with the three LED lighting modules 1308A-1308C that are operational increases, the more quickly the heat produced by the unit 1300 can be transferred.

The second U-shaped member 1400 also defines a number of openings that accommodate various power and user interface structures. To elaborate, second U-shaped member includes: (a) a group of four holes 1410, each of which accommodates one of a group of four buttons 1412 that allow a user to interact with and control the operation of the unit 1300, (b) a hole 1414 for accommodating the display portion of an LCD display unit 1416; (c) a hole 1418 for accommodating an LED power switch 1420 that allows a user to terminate power being provided to the LED lighting modules 1308A-1308C while maintaining power to other elements of the unit 1300, (d) a hole 1421 for receiving a USB port 1432 that allows a USB communication path to be established to a controller 1430, (e) a hole 1422 for accommodating a DC receptacle 1424 that is adapted to receive a plug associated with the power cable that engages the power box or power supply, and (f) a hole 1426 for accommodating a coax connector 1428 for use in establishing a wireless connection with the unit 1300.

Also disposed within the enclosed space of the end module 1310A are (a) a controller 1430 that controls the operation of the LED lighting modules 1308A-1308C, processes user input from the buttons 1412, and provides data/information to a user via the LCD display unit 1416 and processes (b) a terminal strip 1434 that facilitates the establishment of electrical connections between various electrical components associated with the unit 1300, and (c) a 48 V relay 1436 that controls the application of power to the LED lighting modules 1308A-1308C based upon the state of the LED power switch 1420.

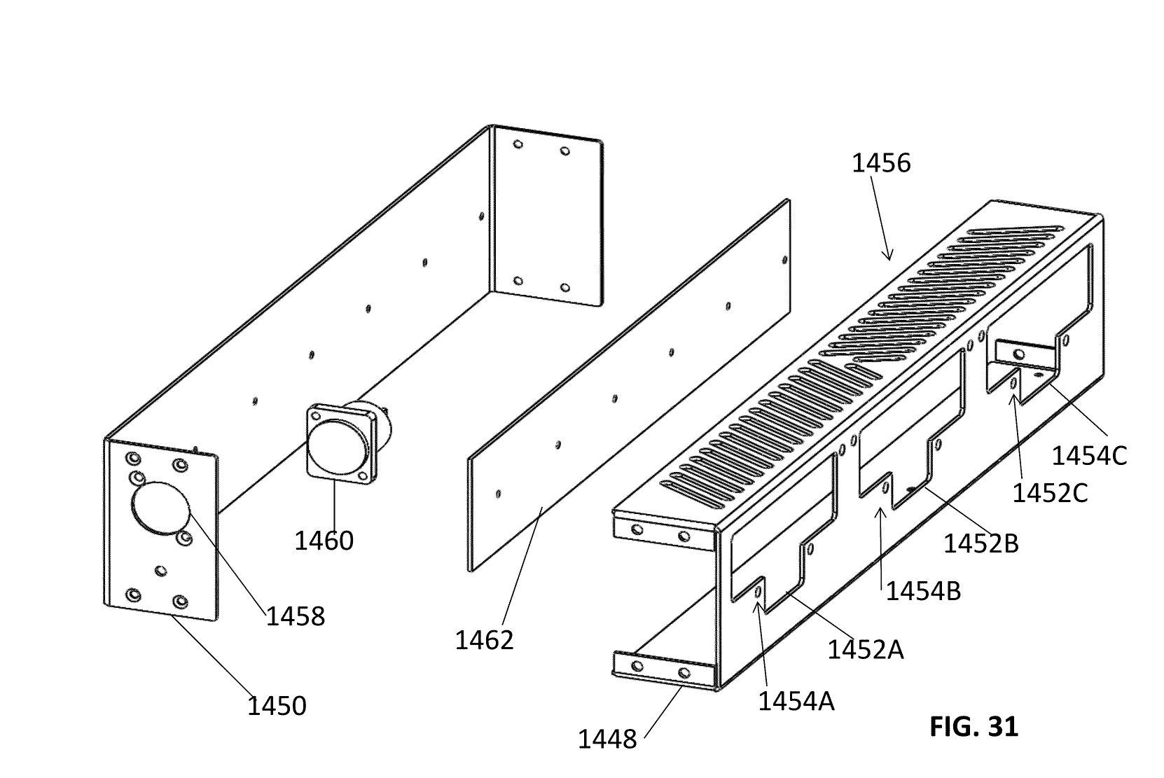

With reference to FIG. 25D, the end module 1310B is a column-like or bar-like structure that extends from a first end 1440 to a second end 1442, has a longitudinal axis 1444, and a substantially constant rectangular cross-sectional profile along the entire length of the module from the first end 1440 to the second end 1442. The end module 1310B includes a housing 1446. With reference to FIG. 31, the housing 1446 is formed from a first U-shaped member 1448 and a second U-shaped member 1450 that are joined to one another with fasteners. The housing 1446 defines an enclosed space that is or can be partially occupied by other components of the end module 1310B. However, a substantial portion of the enclosed space is unoccupied space through which air can be moved to remove heat associated with the operation of any electrical components located in the enclosed space. The first U-shaped member 1448 defines three lighting module cutouts 1452A-1452C and three groups of four holes 1454A-1454C respectively associated with the cutouts. The first group of four holes 1454A receives threading-cutting fasteners that pass through the holes and engage channels 1348A-1348D at the second open end 1322 of the elongated member 1326 to establish a rigid connection between the lighting module 1308A and the end module 1310B. The second and third groups of four holes 1454B, 1454C respectively receive thread-cutting fasteners that engage the channels 1348A-1348D at the second open end 1322 of the lighting modules 1308B, 1308C to establish rigid connections between the lighting modules and the end module 1310A. Further, these connections establish pathways between the enclosed space of the end module 1310B and the first enclosed spaces 1352 of each of the LED lighting modules 1308A-1308C. The pathways can be used to establish electrical connections (a) between electrical circuitry located within the end module 1310B and the LED lighting modules 1308A-1308C and (b) between electrical circuitry located in the LED lighting modules 1308A-1308C. Further, the pathways can be used to move warm air from the enclosed space of the end module 1310B to the exterior environment. To elaborate, the first U-shaped member 1448 also defines fan inlet ports 1456 that are in communication with the enclosed space of the end module 1310B. As such, when at least one of the fans 1334A, 1334B of at least one of the LED lighting modules 1308A-1308C is in operation, relatively cool ambient air is pulled through the fan inlet ports 1456, through the enclosed space of the end module 1310B where heat generated from the operation of any electrical components located in the enclosed space is transferred to the air, through the passageway between the end module 1310B and into the first enclosed space 1352 of the relevant lighting module where heat from the operation of the lighting modules LEDs is transferred to the air. The heated air is then transferred to the ambient atmosphere via the relevant one of fan outlet port 138A, 138B. Generally, as the number of the fans associated with the three LED lighting modules 1308A-1308C that are operational increases, the more quickly the heat produced by the unit 1300 can be transferred.

The second U-shaped member 1450 also defines a hole 1458 for accommodating a DC receptacle 1460 that is adapted to receive a plug associated with the power cable that engages the power box or power supply. The DC receptacle 1460 provides an alternative path for providing power to the fixture 1302 relative to the DC receptacle 1424 associated with the end member 1310A.

Also shown as being located with the enclosed space of the end module 1310B is a driver board 1462. The driver board 1462 is presented as an alternative to the driver board 1336 associated with one of the LED lighting modules 1308A-1308C. Additional driver boards can be located in the enclosed space in place of other driver boards associated with the LED lighting modules 1308A-1308C, if needed or desired. However, the length of the LED lighting modules 1308A-1308C readily accommodates driver boards, as shown in FIG. 27. However, when LED lighting modules of a lesser length are used in a particular lighting fixture, there may be insufficient space to accommodate the driver board 1336. In such situations, the alternative driver board 1462 located in the end module 1310B can be employed.

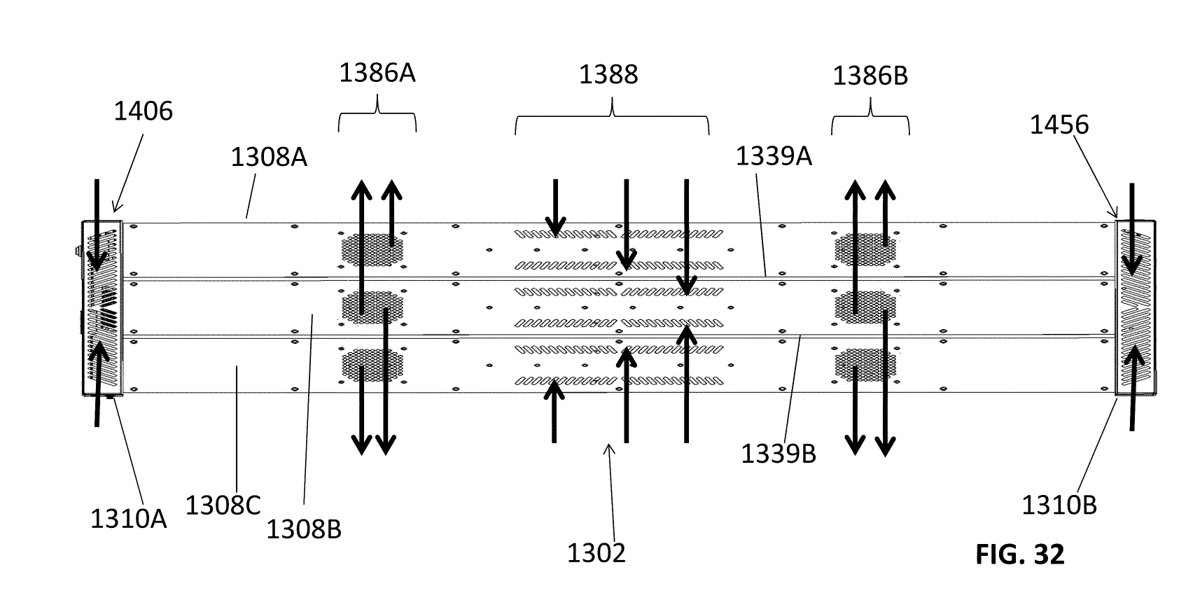

With reference to FIG. 32, the manner in which heat produced by the lighting fixture 1302 is dissipated is further discussed. The lighting fixture 1302 has a ladder-like structure in which: (a) the longitudinal axes 1324 of the lighting modules 1308A-1308C are substantially parallel to one another and correspond to the rungs of a ladder, (b) the longitudinal axes 1394, 1444 of the end modules 1310A, 1310 are substantially parallel to one another and correspond to the rails of a ladder, and (c) the longitudinal axes 1324 of the lighting modules 1308A-1308 are substantially perpendicular to and coplanar with the longitudinal axes 1394, 1444 of the end modules 1310A, 1310B. As such, the first enclosed spaces 1352 of the lighting modules 1308A-1308C are substantially parallel to one another; the enclosed spaces of the end modules 1310A, 1310B are substantially parallel to one another, and the enclosed spaces of the lighting modules 1308A-1308C are substantially perpendicular to and coplanar with the enclosed spaces of the end modules 1310A, 1310B. As such, the enclosed space through which air is moved to by the fans to remove heat from the lighting fixture 1302 has a substantially planar rectilinear shape that facilitates the transfer heat via the fans. Further, each of the fans 1334A, 1334B associated with each of the LED lighting modules 1308A-1308C and the related fan outlet port 1386A or 1386B are positioned so as to primarily service the same volume of the enclosed space defined by the enclosed spaces of the LED lighting modules 1308A-1308C and the end modules 1310A, 1310B.

With continuing reference to FIG. 32, the LED lighting modules 1308A-1308C are supported by the end modules 1310A, 1310B such that there is a gap 1389A between LED lighting modules 1308A, 1308B and a gap 1389B between LED lighting module 1308B, 1308C. The gaps 1389A, 1389B facilitate the dissipation of heat from the sides of the elongated members that define the gaps.

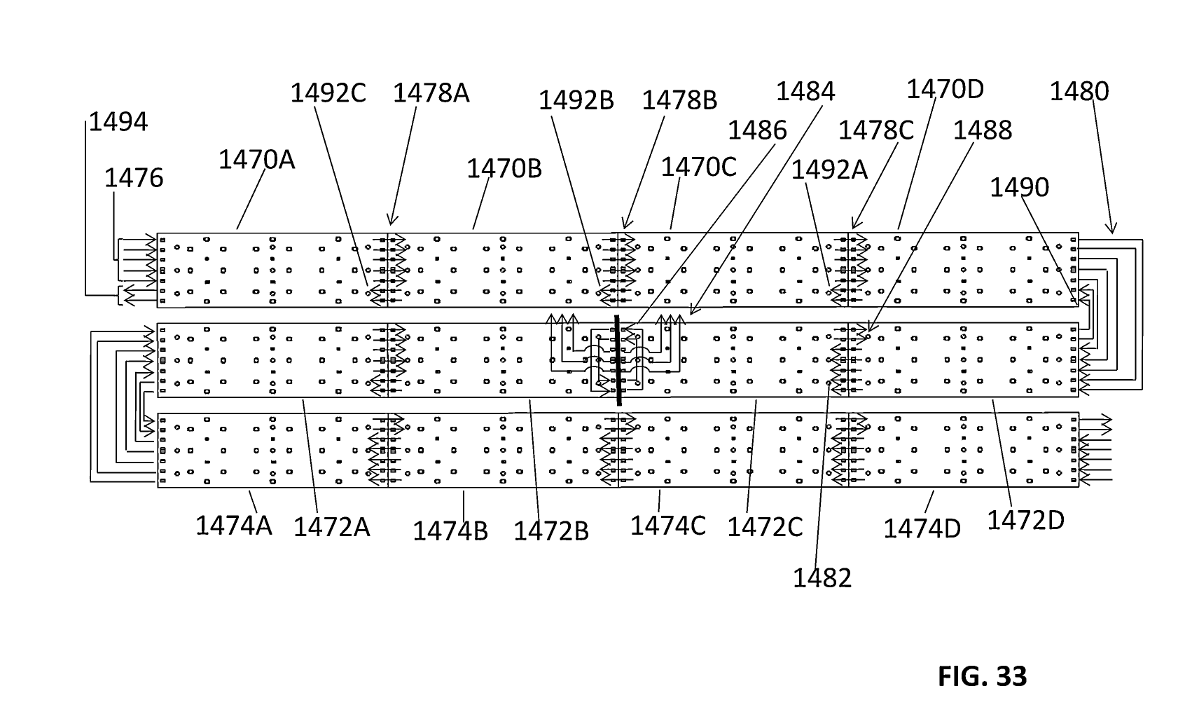

With reference to FIG. 33, the electrical connections associated with the four LED light boards 1328A-1328D associated with each of the LED lighting modules 1308A-1308C is described. In FIG. 33, the four LED light boards associated with the LED lighting module 1308A are identified as light boards 1470A-1470D; the four LED light boards associated with the LED lighting module 1308B are identified as light boards 1472A-1472D; and the four LED light boards associated with the LED lighting module 1308C are identified as light boards 1474A-1474D. The driver board 1336 associated with the LED lighting module 1308A is capable of driving six LED light boards. Consequently, the driver board 1336 drives LED light boards 1470A-1470D of the LED lighting module 1308A and LED light boards 1472C, 1472D of the LED lighting module 1308B. A second driver board is employed to drive the LED light boards 1474A-147D of the LED lighting module 1308C and the LED light boards 1472A, 1472B of the LED lighting module 1308B.

The driver board 1336 applies the LED control signals for each of the five different channels (amber, blue, red, white, and uv) to the LED light board 1470A via five jumper wires 1476. These five control signals are transmitted from LED light board 1470A to LED light boards 1470B-1470D in succession by jumper wires 1478A-1478C. Jumper wires 1480 transfer the control signals from the LED light board 1470D to the LED light board 1472D. The jumper wires 1480 traverse a pathway between the lighting module 1308A and the lighting module 1308B located in the enclosed space of the end module 1310B. Jumper wires 1482 convey the five control signals from LED light board 1472D to LED light board 1472C. The control signals associated with the red, white, and uv channels terminate at LED light board 1472C and return to the driver board 1336 via jumper wires 1484. However, the control signals associated with the red and blue channels are transferred to the other side of the LED light board 1472C via jumper wires 1486. These control signals are transferred from the LED light board 1472C to light board 1472D by jumper wires. These two control signals are transmitted from LED light board 1472D to LED light board 1470D via jumper wires 1490 that traverse a path within the enclosed space of the end module 1310B. The amber and blue control signals are successively transferred from the LED light card 1470D to LED light cards 1470C-1470A via jumper wires 1492A-1492C. The amber and blue control signals terminate with LED light card 1470A and return to the driver board 1336 via jumper wires 1494. The jumper wire structure for conveying control signals from the second driver board to LED light cards 1474A-1474D and LED light card 1472A, 1472B is substantially similar to that described with respect to the driver board 1336. Notably, the jumper wires used to transfer control signals between the LED light card 1474A associated with the LED lighting module 1308C to the LED light card 1742A associated with the LED lighting module 1308B follow a path that traverses the enclosed space of the end module 1310A. The second driver board is associated with LED lighting module 1308C to facilitate the jumper wiring. However, it is feasible to associate the first driver board 1336 with any one of the LED lighting modules 1308A-1308C and the second driver board with any one of the LED lighting module 1308A-1308C that is not associated with the first driver board 1336.

Each of the end modules 1310A, 1310 has a substantially constant rectangular cross-sectional profile over the entire length of the module. This substantially constant profile over the entire length of the modules facilitates the production of end modules that can accommodate a lesser number of LED lighting modules (i.e., accommodate only one or two LED lighting modules) or a greater number of LED lighting modules (i.e., more than three LED lighting modules).

The height of the LED lighting modules 1308A-1308C (i.e., the length of one of the side members 1340A, 1340B) is substantially equal to the height of each of the end modules 1310A, 1310B. Further, the LED lighting modules 1308A-1308C are connected to the end modules 1310A, 1310B such that the top surfaces of the LED lighting modules 1308A-1308C and the top surfaces of the end modules 1310A, 1310B are substantially coplanar, and the bottom surfaces of the LED lighting modules 1308A-1308C and the bottom surfaces of the end modules 1310A, 1310B are substantially coplanar. Additionally, the first end surfaces 1390, 1440 of the end modules 1310A, 1310B are substantially coplanar with the side surface 1340 of the LED lighting module 1308A and the second end surfaces 1392, 1442 of the end modules 1310A, 1310B are substantially coplanar with the side surface 1342 of the LED lighting module 1308C. See FIGS. 25A-25C. Due to these coplanar relationships, the lighting fixture 1302 has a box-like characteristic that is further indicative of the scalability of the lighting fixture, i.e., the ability to produce scaled lighting fixtures that include LED lighting modules of different but substantially equal lengths and/or to have a different number of LED lighting modules than lighting fixture 1302.

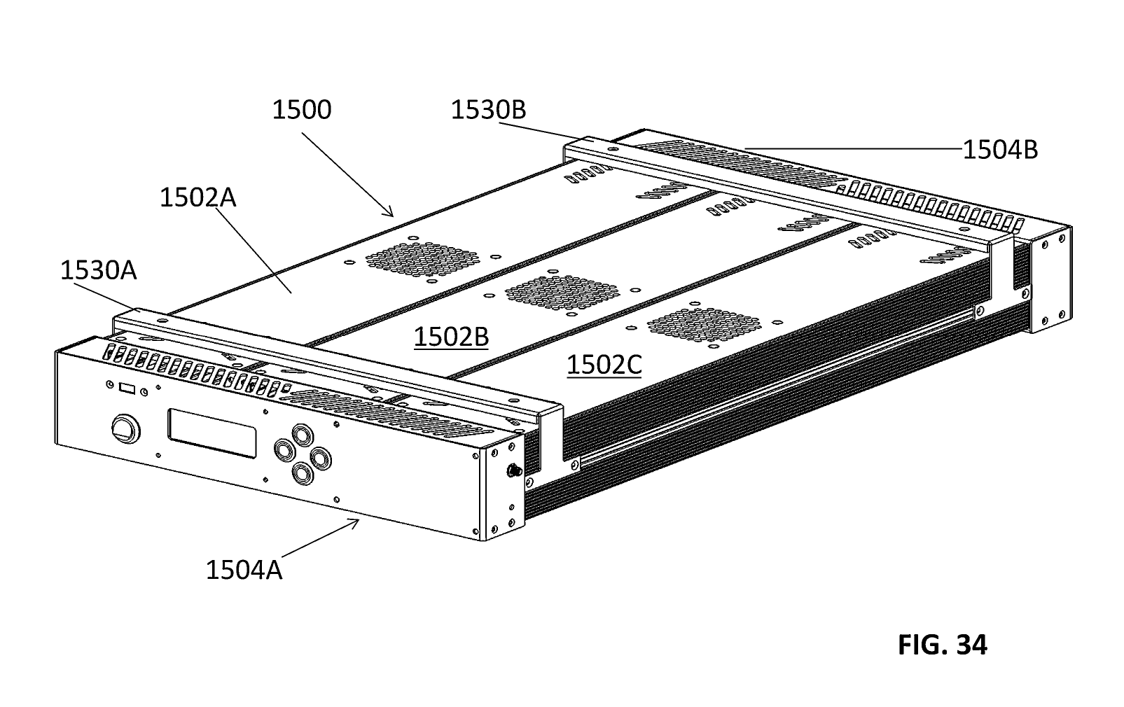

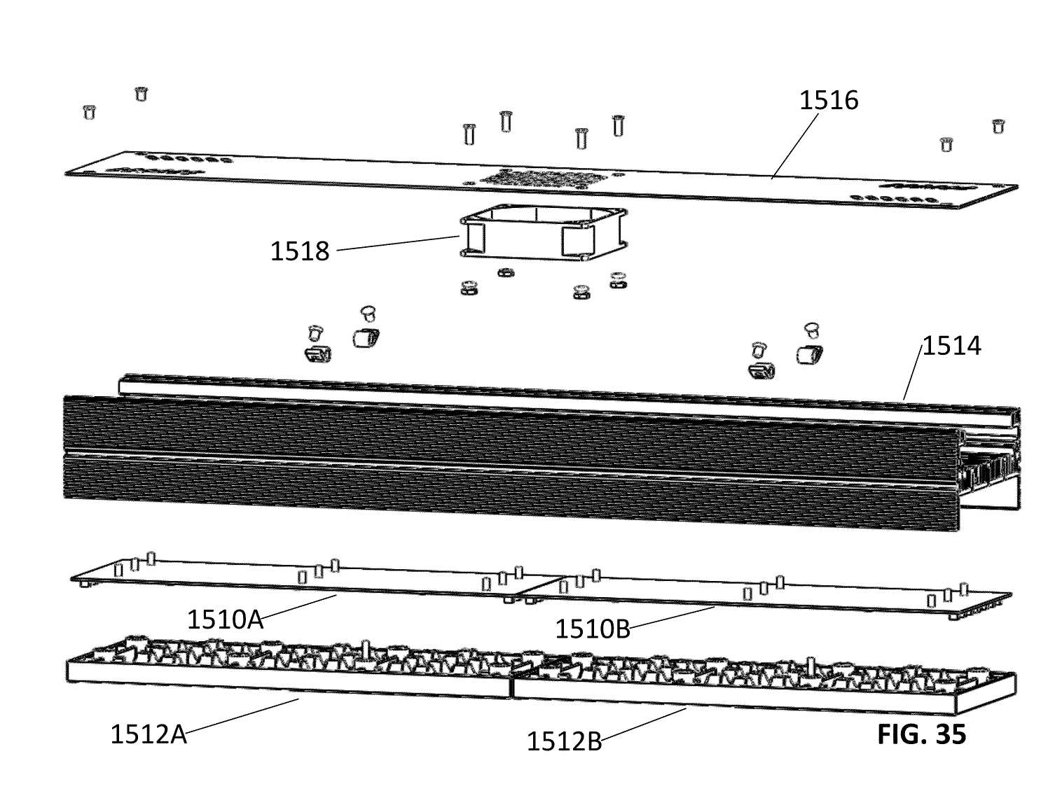

With reference to FIG. 34, the scalability of the lighting fixture of the aquarium unit is demonstrated. A lighting fixture 1500 is comprised of three LED lighting modules 1502A-1502C and end modules 1504A, 1504B. The LED lighting modules 1502A-1502C are scaled down relative to LED lighting modules 1308A-1308C, i.e., of a lesser length. With reference to FIG. 35, the LED lighting module 1502A is described with the understanding that LED lighting modules 1502B, 1502C are each substantially identical to LED lighting module 1502A. The LED lighting module 1502A includes two LED light boards 1510A, 1510B that are substantially identical to the LED light boards utilized in the lighting fixture 1302 and two TIR lens array structures 1512A, 1512B that are substantially identical to the TIR lens array structures used in lighting fixture 1302. The LED lighting module 1502A includes an elongated member 1514 that is substantially identical to the elongated member 1326 associated with the lighting fixture 1302, except that elongated member 1514 is shorter than the elongated member 1326. The LED lighting module 1502A also includes a top plate 1516 that has a rectangular cross-section that is substantially identical to the cross-section of the top plate 1332 associated with the lighting fixture 1302. The top plate 1516 is, however, shorter than top plate 1332 and does have a different layout of fan inlet and outlet ports than top plate 1332. The LED lighting module 1502A includes a fan 1518 that is connected to the top plate 1332 in the same manner that fans 1334A, 1334B are connected to the top plate 1332 in the lighting fixture 1302. The enclosed space provided by the LED lighting 1502A is insufficient to accommodate a driver board. Consequently, the driver board of the lighting fixture 1500 is located in the end module 1504B (a possibility that was described with respect to FIG. 31).

The end modules 1504A, 1504B are externally identical to the end modules 1310A, 1310B associated with the lighting fixture 1302 and are mechanically connected to the LED lighting modules 1502A-1502C in the same manner that end modules 1301A, 1310B engage LED lighting modules 1308A-1308C. As can be appreciated, the end modules 1504A, 1504B can be readily scaled to accommodate a greater or lesser number of LED lighting modules. It should be appreciated that the end modules that employ different structures to rigidly support LED lighting modules are feasible.

With reference to FIG. 34, brackets 1530A, 1530B are adapted to engage the lighting fixture 1500 in a manner that facilitates the hanging of the lighting fixture 1500 from an overhead support. Hanging the lighting fixture 1500 is or may be desirable when the lighting fixture 1500 is used to promote the growth of terrestrial plants instead of marine plants and/or animals.

It will be apparent to those skilled in the art that various modifications and variations can be made to the preferred embodiment of the invention without departing from the scope or spirit of the invention. Other embodiments of the invention will be apparent to those skilled in the art from consideration of the specification and practice of the invention disclosed herein. It is intended that the figures be considered as exemplary only, and not intended to limit the scope and spirit of the invention.

What is claimed is:

1. A lighting structure for use in promoting biological growth comprising:
a plurality of LED modules, each LED module being adapted to support at least one LED;
wherein the plurality of LED modules is “N” LED modules where “N” is two or greater;
wherein each module of the plurality of LED modules extends from a first LED module terminal end to a second LED module terminal end;
wherein each module of the plurality of LED modules has an LED module length that is measured from the first LED module terminal end to the second LED module terminal end;
wherein each module of the plurality of LED modules has substantially the same LED module length;
wherein each LED module has an LED module longitudinal axis extending between the first LED module terminal end and the second LED module terminal end; first and second end modules for engaging the plurality of LED modules;
wherein each of the first and second end modules is adapted to engage no more than “N” LED modules;
wherein each of the first and second end modules extends from a first end module terminal end to a second end module terminal end;
wherein the first end module is rigidly engaged to the first LED module terminal end of each of the plurality of LED modules;
wherein the second end module is rigidly engaged to the second LED module terminal end of each of the plurality of LED modules;
wherein the first end module has a first end module longitudinal axis that extends between the first end module terminal end and the second end module terminal end;
wherein the second end module has a second end module longitudinal axis that extends between the first end module terminal end and the second end module terminal end;
wherein (a) the LED module longitudinal axes are substantially parallel to one another, (b) the first and second end module longitudinal axes are substantially parallel to one another, and (c) the LED module longitudinal axes are substantially perpendicular to the LED module longitudinal axes.

2. The lighting structure, as claimed in claim 1, wherein:
each module of the plurality of LED modules has an LED module cross-section that is substantially uniform between the first and second module terminal ends of the LED module;
each module of the plurality of LED modules has substantially the same LED module cross-section.

3. The lighting structure, as claimed in claim 1, wherein:
the first end module has a first end module cross-section that is substantially uniform between the first and second end module terminal ends of the first end module; and
the second end module has a second end module cross-section that is substantially uniform between the first and second end module terminal ends of the second end module.

4. The lighting structure, as claimed in claim 3, wherein:
each module of the plurality of LED modules has an LED module cross-section that is substantially uniform between the first and second module terminal ends of the LED module;
wherein each module of the plurality of LED modules has substantially the same LED module cross-section;
the LED module cross-section has a LED module cross-section height;
the first end module has first end module cross-section that has a first end module cross-section height;
the second end module has a second end module cross-section that has a second end module cross-section height;
wherein the LED module cross-section height, first end module cross-section height, and second end module cross-section height are substantially equal to one another.

5. The lighting structure, as claimed in claim 1, further comprising:
a plurality of LED circuit boards that are supported by the plurality of LED modules;
wherein each of the plurality of LED circuit boards supports at least one LED;
wherein each of the plurality of LED circuit boards extends from a first board terminal end to a second board terminal end;
wherein each of the plurality of LED circuit boards has a board length as measured from the first board terminal end to the second board terminal end.

6. The lighting structure, as claimed in claim 5, wherein:
at least two of the plurality of LED circuit boards are supported by one of the plurality of LED modules such that the at least two of the plurality of LED circuit boards are positioned end-to-end.

7. The lighting structure, as claimed in claim 6, wherein:
each of the at least two of the plurality of LED circuit boards has substantially the same board length.

8. The lighting structure, as claimed in claim 6, wherein:
each of the at least two of the plurality of LED circuit boards supports a first jumper structure that is associated with the first board terminal end and a second jumper structure that is associated with the second board terminal end;
wherein the first jumper structure of one of the two of the plurality of LED circuit boards is aligned with the second jumper structure of the other of the two of the plurality of LED circuit boards.

9. The lighting structure, as claimed in claim 1, wherein:
at least one of the LED modules includes a heat sink that operatively engages the LED associated with the module and operates to dissipate heat produced during the operation of the LED;
wherein the heat sink has a H-shaped cross-section having two legs that are joined by a transverse section.

10. The lighting structure, as claimed in claim 9, wherein:
the two legs of the heat sink each form a portion of an exterior surface of the at least one of the LED modules.

11. The lighting structure, as claimed in claim 9, wherein:
the heat sink extends from the first LED module terminal end to the second LED module terminal end.

12. The lighting structure, as claimed in claim 1, wherein:
each of the plurality of LED modules defines an module enclosed hollow space;
the first end module defines a first end module enclosed hollow space;
the second end module defines a second end module enclosed hollow space;
wherein each of the module enclosed hollow spaces, the first end module enclosed hollow space, and the second end module enclosed hollow space are in communication with each other and form a combined enclosed space.

13. The lighting structure, as claimed in claim 12, further comprising:
an air circulation structure for moving air within the combined enclosed space.

14. The lighting structure, as claimed in claim 13, wherein:
the air circulation structure comprises:
at least one air intake vent defined by one of the plurality of LED modules, first end module, and second end module;
at least one air outlet vent defined by one of the plurality of LED modules, first end module, and second end module; and
a fan for moving air between the air intake vent and the air outlet vent.

15. The lighting structure, as claimed in claim 1, further comprising:
a first LED for producing a first color of light and having a first angular dispersion;
a second LED for producing a second color of light that is different that the first color of light and having a second angular dispersion;
wherein the first and second LEDs are associated with one of the plurality of LED modules and positioned relative to one another so that the first and second angular dispersions result in the first color of light and second color overlap with one another at a predetermined distance from the first and second LEDs.

16. A lighting structure for use in promoting biological growth comprising:
a plurality of LED modules, each module of the plurality of LED modules being adapted to support at least one LED;
wherein each of the plurality of LED modules extending from a first LED module terminal end to a second LED module terminal end;
wherein each module of the plurality of LED modules has an LED module length that is measured from the first LED module terminal end to the second LED module terminal end;
wherein each module of the plurality of LED modules has substantially the same module length;
wherein each LED module has an LED module longitudinal axis extending between the first LED module terminal end and the second LED module terminal end;
first and second end modules for engaging the plurality of LED modules;
wherein each of the first and second end modules extends from a first end module terminal end to a second end module terminal end;
wherein the first end module is rigidly engaged to the first LED module terminal end of each of the plurality of LED modules;
wherein the second end module is operatively engaged to the second LED module terminal end of each of the plurality of LED modules;
wherein the first end module has a first end module longitudinal axis that extends between the first end module terminal end and the second end module terminal end;
wherein the second end module has a second end module longitudinal axis that extends between the first end module terminal end and the second end module terminal end;
wherein the engaged plurality of LED modules, first end module, and second end module form a module structure in which (a) the LED module longitudinal axes are substantially parallel to one another, (b) the first and second end module longitudinal axes are substantially parallel to one another; and (c) the LED module longitudinal axes are substantially perpendicular to the LED module longitudinal axes.

17. The lighting structure, as claimed in claim 16, further comprising:
a plurality of LED circuit boards associated with each of the plurality of LED modules;
wherein each of the plurality of LED circuit boards extends from a first board terminal end to a second board terminal end;
wherein each of the plurality of LED circuit boards has a board length as measured from the first board terminal end to the second board terminal end;
wherein the board length for each of the plurality of LED circuit boards is substantially the same;
wherein the plurality of LED circuit boards associated with each of the LED modules substantially extends linearly between the first terminal end and the second terminal end of the LED module;
wherein the product of the board length multiplied by an integer that is two or greater is less than or substantially equal to the module length.

18. The lighting structure, as claimed in claim 16, further comprising:
a plurality of LED circuit boards associated with each of the plurality of LED modules;
wherein a first LED circuit board associated with a first LED module of the plurality of LED modules includes a first plurality of LEDs that are connected in parallel;
wherein a second LED circuit board associated with the first LED module includes a second plurality of LEDs that are connected in parallel;
wherein the first plurality of LEDs of the first LED circuit board are connected in series with the second plurality of LEDs of the second LED circuit board.

19. The lighting structure, as claimed in claim 18, further comprising:
the first LED circuit board includes a third plurality of LEDs that are connected in parallel to one another and in series with the first plurality of LED associated with the first LED circuit board.

20. The lighting fixture, as claimed in claim 16, wherein:
each of the plurality of LED modules defines an module enclosed hollow space;
the first end module defines a first end module enclosed hollow space;
the second end module defines a second end module enclosed hollow space;
wherein each of the module enclosed hollow spaces, the first end module enclosed hollow space, and the second end module enclosed hollow space are in communication with each other and form a combined enclosed space.

21. The lighting structure, as claimed in claim 20, further comprising:
at least one air intake vent defined by one of the plurality of LED modules, first end module, and second end module;
at least one air outlet vent defined by one of the plurality of LED modules, first end module, and second end module; and
a fan for moving air between the air intake vent and the air outlet vent.

22. A lighting structure for use in promoting biological growth comprising:
a plurality of LED modules, each module being adapted to support at least one LED;
wherein each of the plurality of LED modules extending from a first LED module terminal end to a second LED module terminal end;
wherein each module of the plurality of LED modules has an LED module length that is measured from the first LED module terminal end to the second LED module terminal end;
wherein each module of the plurality of LED modules has substantially the same module length;
wherein each module of the plurality of LED modules defines an LED module enclosed space;
wherein each LED module has an LED module longitudinal axis extending between the first LED module terminal end and the second LED module terminal end;
first and second end modules for engaging the plurality of LED modules;
wherein each of the first and second end modules extends from a first end module terminal end to a second end module terminal end;
wherein the first end module defines a first end module enclosed space;
wherein the second end module defines a second end module enclosed space;
wherein the first end module is rigidly engaged to the first LED module terminal end of each of the plurality of LED modules;
wherein the second end module is rigidly engaged to the second LED module terminal end of each of the plurality of LED modules;
wherein the first end module has a first end module longitudinal axis that extends between the first end module terminal end and the second end module terminal end;
wherein the second end module has a second end module longitudinal axis that extends between the first end module terminal end and the second end module terminal end;
wherein the engaged plurality of LED modules, first end module, and second end module form a module structure in which (a) the LED module longitudinal axes are substantially parallel to one another, (b) the first and second end module longitudinal axes are substantially parallel to one another; (c) the LED module longitudinal axes are substantially perpendicular to the LED module longitudinal axes; and (d) the LED module enclosed spaces, first end module enclosed space, and second end module enclosed space are in communication with one another and define a combined enclosed space that has a planar-rectilinear characteristic.

23. The lighting structure, as claimed in claim 22, further comprising:
a plurality of LED circuit boards associated with each of the plurality of LED modules;
wherein each of the plurality of LED circuit boards extends from a first board terminal end to a second board terminal end;
wherein each of the plurality of LED circuit boards has a board length as measured from the first board terminal end to the second board terminal end;
wherein the board length for each of the plurality of LED circuit boards is substantially the same;
wherein the plurality of LED circuit boards associated with each of the LED modules substantially extend linearly between the first terminal and the second terminal end of the LED module;
wherein the product of the board length multiplied by an integer that is two or greater is less than or substantially equal to the module length.

24. The lighting structure, as claimed in claim 22, further comprising:
at least one air intake vent defined by one of the plurality of LED modules, first end module, and second end module and in communication with the combined enclosed space;
at least one air outlet vent defined by one of the plurality of LED modules, first end module, and second end module and in communication with the combined enclosed space; and
a fan for moving air in the module enclosed space located between the air intake vent and the air outlet vent.
